(19) United States
(12) Patent Application Publication
(10) Pub. No.: US 2018/0164801 A1
(43) Pub. Date: Jun. 14, 2018

(54) METHOD FOR OPERATING UNMANNED AERIAL VEHICLE AND ELECTRONIC DEVICE FOR SUPPORTING THE SAME

(71) Applicant: Samsung Electronics Co., Ltd., Gyeonggi-do (KR)

(72) Inventors: Tae Kyun KIM, Gyeonggi-do (KR); Wu Seong LEE, Chungcheongnam-do (KR); Seung Nyun KIM, Incheon (KR); Yong Sang YUN, Gyeonggi-do (KR)

(21) Appl. No.: 15/825,454

(22) Filed: Nov. 29, 2017

(30) Foreign Application Priority Data
Dec. 14, 2016 (KR) 10-2016-0170042

(51) Int. Cl. G05D 1/00; B64C 39/02; G08G 5/00

(52) U.S. Cl. CPC G05D 1/0016; G05D 1/0022; B64C 2201/146; G08G 5/0069; B64C 39/024

(57) ABSTRACT

An electronic device is provided. The electronic device includes a communication circuit configured to establish a communication channel with an aerial vehicle, a sensor configured to collect location information and orientation information, a memory configured to store an application associated with controlling the aerial vehicle, a processor electrically connected with the communication circuit, the sensor, and the memory. The processor may be configured to calculate a valid range defining a space where it is possible to operate the aerial vehicle, based on location and/or orientation information of the electronic device.

### CLAIM OF PRIORITY

This application claims the benefit under 35 U.S.C. § 119(a) of a Korean patent application filed on Dec. 14, 2016 in the Korean Intellectual Property Office and assigned Serial number 10-2016-0170042, the entire disclosure of which is hereby incorporated by reference.

### TECHNICAL FIELD

The present disclosure generally relates to operations of an unmanned aerial vehicle (UAV).

### BACKGROUND

In general, UAVs may have various names, such as drone or unmanned aircraft system (UAS). UAVs are aerial vehicles that do not require drivers onboard, and are manufactured to perform specified missions. These UAVs may be wirelessly connected to remote controllers so that they are remotely controlled. A drone may be used for industry and leisure, such as aerial image capture or crop-dusting.

### SUMMARY

A controller for a UAV may be an input device that includes a joystick or a touch pad or the like for controlling the UAV. The UAV may move in a constant direction depending on control information received from the input device. Since the UAV is subject to inertial motion, an input prediction range input after a user recognizes the UAV may be often different from the distance in which the UAV actually moves. Further, since the movement speed of the UAV according to an input predicted by the user is often different from the real movement speed of the UAV, it is very difficult for an unskilled user to control the UAV. Thus, it is not easy to operate the UAV accurately. And therefore, when there is a situation where loss of lives or property damage may be caused by the inaccurate operation of the UAV, it is difficult for the user to properly respond to the situation.

Aspects of the present disclosure are to address at least the above-mentioned problems and/or disadvantages and to provide at least the advantages described below. Accordingly, an aspect of the present disclosure is to provide a method for controlling operations of a UAV to stably operate the UAV by operating the UAV within a limited range and an electronic device for supporting the same.

Accordingly, another aspect of the present disclosure is to provide a method for controlling operations of a UAV to prevent the UAV from being operated by mistake by locating the UAV in a safe area using a limit range in which the UAV may be operated and an electronic device for supporting the same.

Various embodiments of the present disclosure may safely operate a UAV by operating the UAV in a limited range, and may limit the damages caused by improper operations of the UAV.

In accordance with another aspect of the present disclosure, an electronic device may include a housing, a display, at least one first sensor located in the housing and configured to generate first data associated with an orientation of the housing, a second sensor located in the housing and configured to generate second data associated with a location of the housing, a wireless communication circuit located in the housing, a processor located in the housing and electrically connected with the display, the at least one first sensor, the second sensor, and the wireless communication circuit, and a memory located in the housing, wherein the memory stores instructions, when executed, cause the processor to establish a wireless communication channel with an unmanned aerial vehicle (UAV) via the wireless communication circuit, receive the first data from the at least one first sensor, obtain the orientation of the housing based on at least part of the received first data, receive the second data from the second sensor, obtain the location of the housing based on at least part of the received second data, based on the orientation and/or the location, determine a valid range in which the UAV can operate, and transmit a control signal to the UAV via the wireless communication circuit, where the control signal is executed by the UAV such that the UAV stays within in the valid range.

In accordance with another aspect of the present disclosure, an electronic device is provided. The electronic device may include a communication circuit configured to establish a communication channel with an aerial vehicle, a sensor configured to collect location information and orientation information, a memory configured to store an application associated with controlling the aerial vehicle, and a processor electrically connected with the communication circuit, the sensor, and the memory, where the processor is configured to calculate a valid range defining a space where it is possible to operate the aerial vehicle, based on location and/or orientation information of the electronic device.

In accordance with another aspect of the present disclosure, a method for controlling operation of a UAV is provided. The method may include establishing, by an electronic device, a communication channel with the UAV, collecting, by the electronic device, location information and orientation information of the electronic device, calculating, by the electronic device, a valid range defining a space where it is possible to operate the UAV, based on the collected location and/or orientation information of the electronic device, collecting, by the electronic device, location information of the UAV, determine, by the electronic device, whether the UAV is within the valid range; and transmitting, by the electronic device, control information associated with operating the UAV to the UAV as a result of the determination.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a drawing illustrating an example of a UAV operation environment according to an embodiment of the present disclosure;

FIG. 2 is a block diagram illustrating an example of an electronic device according to an embodiment of the present disclosure;

FIG. 3 is a block diagram illustrating an example of a configuration of a processor according to an embodiment of the present disclosure;

FIG. 4 is a block diagram illustrating an example of an aerial vehicle according to an embodiment of the present disclosure;

FIG. 5 is a block diagram illustrating an example of a configuration of a processor of an aerial vehicle according to an embodiment of the present disclosure;

FIG. 6 is a signal sequence diagram illustrating an example of a signal flow between devices in a UAV operation environment according to an embodiment of the present disclosure;

FIG. 7 is a drawing illustrating an example of a valid range according to an embodiment of the present disclosure;

FIG. 8 is a drawing illustrating another example of a valid range according to an embodiment of the present disclosure;

FIG. 9 is a drawing illustrating an example of a change in valid range according to an embodiment of the present disclosure;

FIG. 10 is a drawing illustrating another example of a change in valid range according to an embodiment of the present disclosure;

FIG. 11 is a drawing illustrating another example of a change in valid range according to an embodiment of the present disclosure;

FIG. 12 is a drawing illustrating an example of operation of a valid range of an electronic device connected with a camera according to an embodiment of the present disclosure;

FIG. 13 is a flowchart illustrating an example of a signal flow between devices in connection with operation of a valid range of a camera-based aerial vehicle according to an embodiment of the present disclosure;

FIG. 14 is a signal sequence diagram illustrating an example of a signal flow between devices in connection with operation of a valid range based on a camera according to an embodiment of the present disclosure;

FIG. 15 is a drawing illustrating an example of a screen interface associated with operation of a valid range according to an embodiment of the present disclosure;

FIG. 16 is a flowchart illustrating an example of an operation method of an electronic device associated with operating a UAV according to an embodiment of the present disclosure;

FIG. 17 is a flowchart illustrating an example of an operation method of an aerial vehicle associated with operating a UAV according to an embodiment of the present disclosure;

FIG. 18 illustrates an example of an unmanned aerial vehicle and a remote controller according to an embodiment of the present disclosure.

FIG. 19 illustrates an example of an unmanned aerial vehicle according to an embodiment of the present disclosure.

FIG. 20 illustrates another example of an unmanned aerial vehicle according to an embodiment of the present disclosure.

FIG. 21 illustrates a program module of an unmanned aerial vehicle according to an embodiment of the present disclosure.

Throughout the drawings, it should be noted that like reference numbers are used to depict the same or similar elements, features, and structures.

### DETAILED DESCRIPTION

Various embodiments of the present disclosure may be described with reference to accompanying drawings. Accordingly, those of ordinary skill in the art will recognize that modifications, equivalents, and/or alternatives of the various embodiments described herein can be made without departing from the scope and spirit of the present disclosure.

In the disclosure disclosed herein, the expressions “have,” “may have,” “include,” “comprise,” “may include,” and “may comprise” used herein indicate existence of corresponding features (e.g., elements such as numeric values, functions, operations, or components) but do not exclude presence of additional features.

In the disclosure disclosed herein, the expressions “A or B,” “at least one of A or/and B,” or “one or more of A or/and B,” and the like used herein may include any and all combinations of one or more of the associated listed items. For example, the term “A or B,” “at least one of A and B,” or “at least one of A or B” may refer to all of the case (1) where at least one A is included, the case (2) where at least one B is included, or the case (3) where both of at least one A and at least one B are included.

The terms, such as “first,” “second,” and the like used herein may refer to various elements of various embodiments, but do not limit the elements. Furthermore, such terms may be used to distinguish one element from another element. For example, “a first user device” and “a second user device” may indicate different user devices regardless of the order or priority thereof. For example, “a first user device” and “a second user device” indicate different user devices.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for,” “having the capacity to,” “designed to,” “adapted to,” “made to,” or “capable of” The term “configured to” must not mean only “specifically designed to” in hardware. Instead, the expression “a device configured to” may mean that the device is “capable of” operating together with another device or other components. CPU, for example, a “processor configured to perform A, B, and C” may mean a dedicated processor (e.g., an embedded processor) for performing a corresponding operation or a generic-purpose processor (e.g., a central processing unit (CPU) or an application processor) which may perform corresponding operations by executing one or more software programs which are stored in a memory device.

Terms used in the present disclosure are used to describe specified embodiments and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, e-book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, wearable devices (e.g., head-mounted-devices (HMDs), such as electronic glasses), an electronic apparel, electronic bracelets, electronic necklaces, electronic appcessories, electronic tattoos, smart watches, and the like.

According to another embodiment, the electronic devices may be home appliances. The home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, or the like.

According to another embodiment, the photographing apparatus may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices), navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to another embodiment, the electronic devices may include at least one of parts of furniture or buildings/structures, electronic boards, electronic signature receiving devices, projectors, or various measuring instruments (e.g., water meters, electricity meters, gas meters, or wave meters, and the like). In the various embodiments, the electronic device may be one of the above-described various devices or a combination thereof. An electronic device according to an embodiment may be a flexible device. Furthermore, an electronic device according to an embodiment may not be limited to the above-described electronic devices and may include other electronic devices and new electronic devices according to the development of technologies.

Hereinafter, an electronic device according to the various embodiments may be de scribed with reference to the accompanying drawings. The term “user” used herein may refer to a person who uses an electronic device or may refer to a device (e.g., an artificial intelligence electronic device) that uses an electronic device.

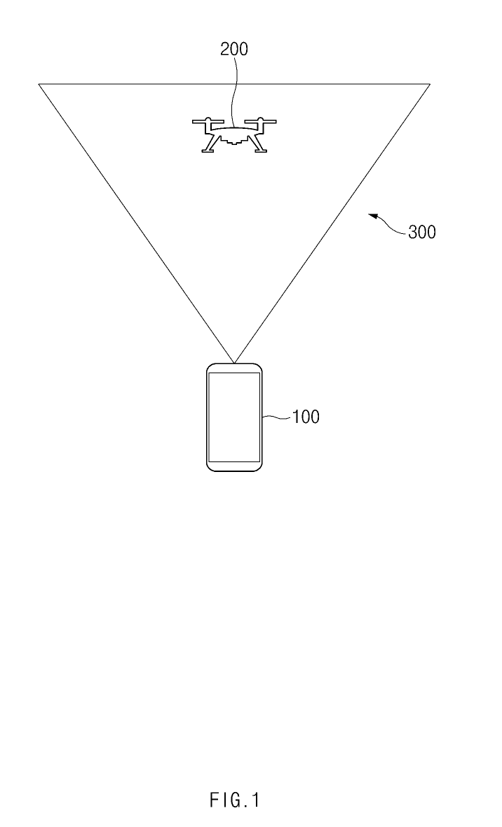

FIG. 1 is a drawing illustrating an example of an unmanned aerial vehicle (UAV) operation environment according to an embodiment of the present disclosure.

Referring to FIG. 1, the UAV operation environment according to an embodiment of the present disclosure may include an electronic device 100 (or a control device) and an aerial vehicle 200 (or a UAV).

According to one embodiment, in the UAV operation environment, a valid range 300 (or a virtual fence or a safe operation valid range) in which the aerial vehicle 200 may drive relative to the electronic device 100 may be set. The aerial vehicle 200 may be operated within the valid range 300. The motion or movement of the electronic device 100 may be used to control the aerial vehicle 200. Thus, the valid range 300 may minimize a situation where loss of life occurs by preventing the UAV from moving to an area the user does not want. Alternatively, although the UAV is moved to an area the user does not intend, he or she may easily change movement of the aerial vehicle 200 or may limit movement of the aerial vehicle 200 by changing the orientation (or position) of the electronic device 100.

According to one embodiment, the aerial vehicle 200 may include at least one propeller. The aerial vehicle 200 may move laterally at a constant altitude above the ground. The aerial vehicle 200 may further include devices such as cameras. The aerial vehicle 200 may capture images in response to control of the electronic device 100 using the camera. The aerial vehicle 200 may transmit the captured images to an external device (e.g., the electronic device 100 or a separately specified server or external electronic device).

According to one embodiment of the present disclosure, the aerial vehicle 200 may be operated within only a constant valid range in response to a location and orientation of the electronic device 100. The aerial vehicle 200 may be operated within a specified angle range with respect to a direction the electronic device 100 faces and a point where the electronic device 100 is located. If an input for departing from the valid range is received by the aerial vehicle 200, the aerial vehicle 200 may maintain a hovering state (e.g., a state where the aerial vehicle 200 floats at a specified height and/or location) at a boundary of the valid range. The aerial vehicle 200 may support a safe operation function and a manual operation function. For example, if the safe operation function is selected, the aerial vehicle 200 may be operated within the specified valid range with respect to the electronic device 100. If the manual operation function is selected, the aerial vehicle 200 may be operated without the limit of the valid range.

The aerial vehicle 200 may receive location information and orientation information of the electronic device 100 from the electronic device 100. The aerial vehicle 200 may calculate a valid range based on the received location and orientation information of the electronic device 100. The aerial vehicle 200 may be operated to be within the calculated valid range.

The electronic device 100 may establish a communication channel of the aerial vehicle 200 and may provide control information to the aerial vehicle 200. The control information may include requests to adjust the movement direction, the altitude, the movement speed, a driving type (e.g., a selfie type of capturing a user who operates the electronic device 100 or a tracking type of tracking and capturing a specified object), or the like of the aerial vehicle 200. The control information may be generated according to a user input received via an input device included in the electronic device 100.

The electronic device 100 may calculate a valid range in which the aerial vehicle 200 will be operated, based on location information and orientation information. The electronic device 100 may provide the calculated valid range information to the aerial vehicle 200. According to an embodiment, if the electronic device 100 controls the aerial vehicle 200 while it is located in a first direction (e.g., a front direction), a valid range (or a flight area) may be set within a radius range (e.g., a field of view (FOV)) set left and right with respect to the first direction. If an axis of the electronic device 100 is moved (or if an orientation is changed) to change an oriented direction during control of the aerial vehicle 200, the electronic device 200 may detect an amount (e.g., an angle) of motion or movement and may set another valid range with respect to a new oriented direction. Thus, the aerial vehicle 200 may be safely operated within an FOV of an operator by operating the aerial vehicle 200 within a newly updated valid range with respect to an oriented direction of the operator who holds the electronic device 100.

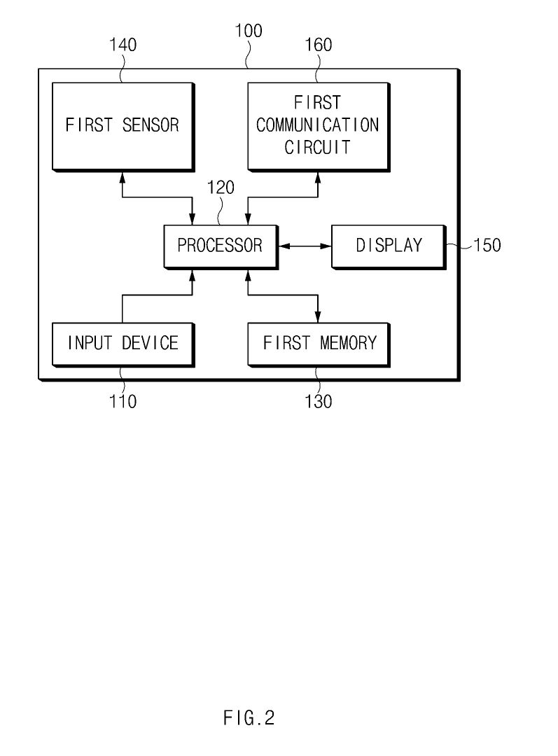

FIG. 2 is a block diagram illustrating an example of an electronic device according to an embodiment of the present disclosure.

Referring to FIG. 2, an electronic device 100 according to an embodiment of the present disclosure may include a housing and may include an input device 110, a processor 120, a first memory 130, a first sensor 140, a display 150, and a first communication circuit 160, at least some of which are located within the housing.

According to one embodiment, the input device 110 may generate an input signal according to a user input of the electronic device 100. The input device 110 may include, for example, a joystick, buttons, a touch pad, etc. The input device 110 may be provided in the form of a touch screen display panel and may be implemented as at least one virtual object associated with controlling an aerial vehicle 200 of FIG. 1. According to an embodiment, the input device 110 may transmit a user input signal associated with selecting a safe operation function or a manual operation function, a user input signal associated with operation of the aerial vehicle 200 (e.g., a signal associated with movement in at least one of an upper and lower direction, a left and right direction, a front and rear direction, or a diagonal direction), a user input signal associated with adjusting a movement speed of the aerial vehicle 200, or the like to the processor 120 in response to a user input. The input device 110 may transmit an input signal or the like for selecting a specific operation type (e.g., a selfie type, a tracking type, or the like) to the processor 120 in response to a user input. According to various embodiments, the electronic device 100 may include a microphone, a speaker, or the like. The microphone may be included in the input device 110. The input device 110 including the microphone may obtain a user voice input and may process an input based on voice recognition for the obtained user voice input. The processor 120 may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for.” In addition, an artisan understands and appreciates that a “processor” or “microprocessor” may be hardware in the claimed disclosure. Under the broadest reasonable interpretation, the appended claims are statutory subject matter in compliance with 35 U.S.C. § 101.

The first memory 130 may store at least one application or data associated with operating the electronic device 100. According to an embodiment, the first memory 130 may store an operation application program associated with operating the aerial vehicle 200. The operation application program may include an instruction set (or an instruction group, a routine, or the like) to establish a communication channel (e.g., a Bluetooth communication channel or the like) with the aerial vehicle 200, an instruction set to enable a safe operation function or a manual operation function in response to a user input, an instruction set to collect location information and orientation information of the electronic device 100 when the safe operation function is performed, an instruction set to set a valid range based on the collected location and orientation information, and/or an instruction set to transmit information about the valid range to the aerial vehicle 200. The operation application program may further include an instruction set to transmit the location information and the orientation information to the aerial vehicle 200. The operation application program may also include an instruction set to transmit control information for moving the aerial vehicle 200 in a certain direction to the aerial vehicle 200 in response to a user input.

The first sensor 140 may include at least one sensor for collecting location information and orientation information of the electronic device 100. For example, the first sensor 140 may include a position sensor (e.g., a global positioning system (GPS)) associated with collecting location information of the electronic device 100. The first sensor 140 may include an orientation sensor (e.g., an acceleration sensor, a geomagnetic sensor, a gyro sensor, or the like) for collecting orientation information of the electronic device 100. The first sensor 140 may collect location information and orientation information in response to control of the processor 120 and may provide the collected location and orientation information to the processor 120.

The display 150 may output at least one screen associated with operating the electronic device 100. According to an embodiment, the display 150 may output a virtual operation object associated with controlling movement of the aerial vehicle 200. The virtual operation object may include an object indicating movement in at least one of a left and right direction, an upper and lower direction, a front and rear direction, or a diagonal direction of the aerial vehicle 200, an object for adjusting a movement speed of the aerial vehicle 200, an object associated with adjusting an altitude of the aerial vehicle 200, an object for determining an operation type of the aerial vehicle 200, or the like. The display 150 may output a menu or an icon for selecting any one of a safe operation function or a manual operation function of the aerial vehicle 200. According to an embodiment, the display 150 may output a boundary image, a boundary line, or the like corresponding to a set valid range. The display 150 may output an image captured by a camera located in the electronic device 100. The display 150 may output an image captured by a camera located in the aerial vehicle 200.

The first communication circuit 160 may support a communication function of the electronic device 100. According to an embodiment, the first communication circuit 160 may establish a communication channel with the aerial vehicle 200. The first communication circuit 160 may include a circuit for establishing a short-range communication channel. The first communication circuit 160 may transmit at least one of control information associated with setting a safe operation function or a manual operation function, control information associated with adjusting a movement direction or speed of the aerial vehicle 200, or control information associated with an operation type of the aerial vehicle 200 to the aerial vehicle 200 in response to user control. According to an embodiment of the present disclosure, the first communication circuit 160 may transmit current location information and orientation information of the electronic device 100 to the aerial vehicle 200 or may transmit a valid range calculated based on the current location information and the orientation information of the electronic device 100 to the aerial vehicle 200.

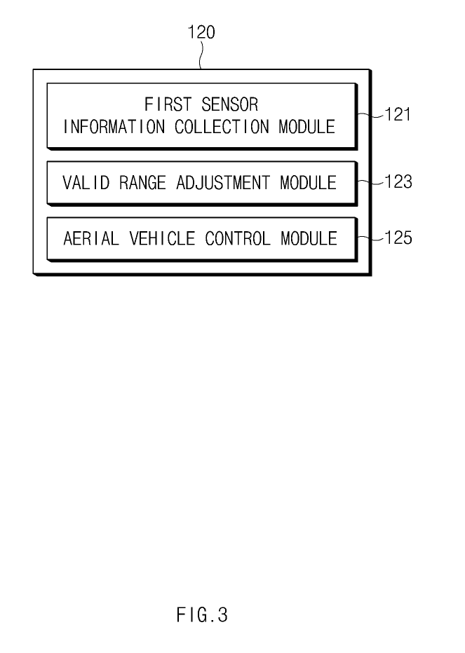

The processor 120 may process or transmit a signal associated with control of the electronic device 100. According to an embodiment, the processor 120 may control to establish a communication channel between the electronic device 100 and the aerial vehicle 200 in response to a user input. The processor 120 may transmit a control signal associated with setting a safe operation function or a manual operation function to the aerial vehicle 200 in response to a user input or a set function. The processor 120 may calculate a valid range based on location information and orientation information of the electronic device 100. The processor 120 may transmit information about the calculated valid range to the aerial vehicle 200. The processor 120 may control the aerial vehicle 200 to be operated within the valid range. In this regard, the processor 120 may include elements shown in FIG. 3.

FIG. 3 is a block diagram illustrating an example of a configuration of a processor according to an embodiment of the present disclosure.

Referring to FIG. 3, a processor 120 according to an embodiment of the present disclosure may include a first sensor information collection module 121 (or a sub-processor), a valid range adjustment module 123, or an aerial vehicle control module 125. At least one of the first sensor information collection module 121, the valid range adjustment module 123, or the aerial vehicle control module 125 may include at least part of the processor 120. Alternatively, at least one of the first sensor information collection module 121, the valid range adjustment module 123, or the aerial vehicle control module 125 may be implemented as an independent processor and may communicate with the processor 120 to perform signaling associated with controlling an aerial vehicle 200 of FIG. 1.

According to one embodiment, the first sensor information collection module 121 may collect location information and orientation information in response to a user input. For example, if a communication channel is established with the aerial vehicle 200 in connection with operating the aerial vehicle 200, the first sensor information collection module 121 may collect current location information and orientation information of an electronic device 100 of FIG. 2. The first sensor information collection module 121 may enable a position sensor (e.g., a GPS) and an acceleration sensor (or a geomagnetic sensor or a gyro sensor). The first sensor information collection module 121 may transmit the collected location and orientation information to the valid range adjustment module 123.

If receiving the location information and the orientation information from the first sensor information collection module 121, the valid range adjustment module 123 may calculate a valid range based on the location information and the orientation information. The valid range adjustment module 123 may determine (or verify) a user setting associated with calculating a valid range. For example, the valid range adjustment module 123 may determine (or verify) whether a specified angle (e.g., 60 degrees, 90 degrees, 120 degrees, or the like from left to right with respect to a front direction) is set with respect to a specific direction of the electronic device 100 (e.g., the front direction in a state where a user holds the electronic device 100). If there is no separate user setting, the valid range adjustment module 123 may use a default setting (e.g., 90 degrees) to calculate a valid range. The valid range adjustment module 123 may determine whether the valid range is to have any number of shapes, such as a cone, a triangular pyramid, a square pole, and the like. If there is no separate setting, the valid range adjustment module 123 may apply a default setting (e.g., the cone) to the calculation of the valid range. The valid range may be configured according to an independent criterion for an upper and lower region or a left and right region based on location information of the electronic device 100. For example, an upper and lower direction may be set to a range for a specified height region, and a left and right direction may be set to a range in the form of a straight line or a curved line according to a set angle.

The valid range adjustment module 123 may determine whether a maximum separation distance between the aerial vehicle 200 and the electronic device 100 is set. According to one embodiment, the valid range adjustment module 123 may determine whether a limit range is set. The limit range may be set, for example, at a distance where communication between the aerial vehicle 200 and the electronic device 100 is disconnected. In another example, the limit range may be set at a distance to prevent collision between the aerial vehicle 200 and some obstruction, such as a building structure, a person, or the ground.

According to one embodiment, the user may input various settings associated with a valid range through a user interface. For example, the valid range adjustment module 123 may output a user interface (e.g., an angle setting screen), associated with at least one of operation for setting an angle, operation for setting a form of a valid range, operation for setting a maximum separation distance, or operation for setting a movement limit range in at least one of upper and lower directions, on a display 150 of FIG. 2. The valid range adjustment module 123 may transmit information about the calculated valid range to the aerial vehicle 200 in real time. The calculating of the valid range may be performed by the aerial vehicle 200. In this case, the valid range adjustment module 123 may be a module operated by an aerial vehicle processor 220 of the aerial vehicle 200.

The aerial vehicle control module 125 may establish a communication channel with the aerial vehicle 200 in response to a user input or according to a set schedule. The aerial vehicle control module 125 may enable a first communication circuit 160 of FIG. 2 in response to a user input and may control the aerial vehicle 200 to start in an initial hovering state (e.g., a fixed state where the aerial vehicle 200 floats up at a constant height from the ground). The aerial vehicle control module 125 may generate control information associated with operating the aerial vehicle 200 in response to a user input and may transmit the generated control information to the aerial vehicle 200. The control information associated with operating the aerial vehicle 200 may include, for example, movement direction information of the aerial vehicle 200, movement speed information of the aerial vehicle 200, operation type information of the aerial vehicle 200, or information about camera control or the like.

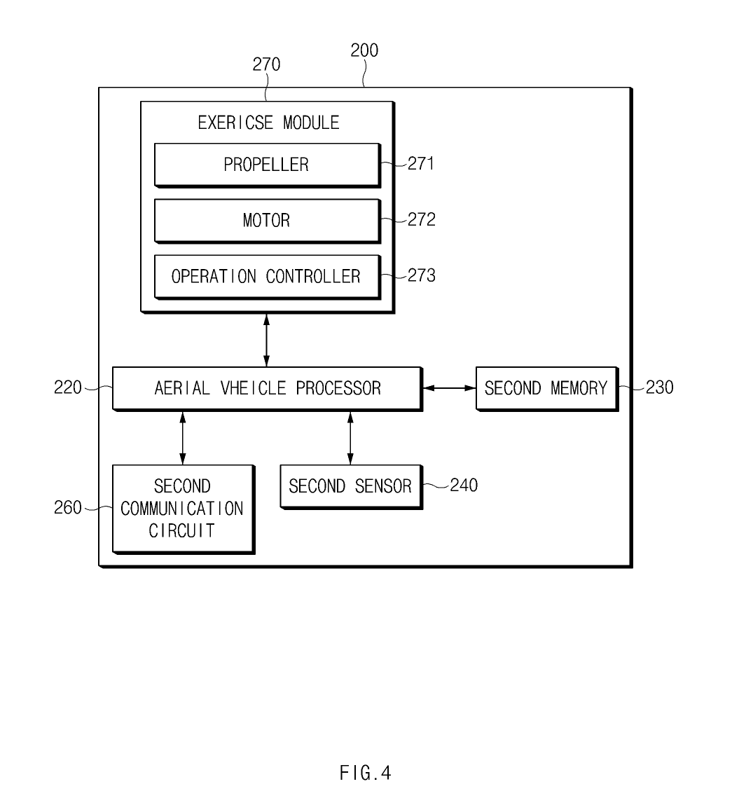

FIG. 4 is a block diagram illustrating an example of an aerial vehicle according to an embodiment of the present disclosure.

Referring to FIG. 4, an aerial vehicle 200 according to an embodiment of the present disclosure may include a housing and may include an aerial vehicle processor 220, a second memory 230, a second sensor 240, a second communication circuit 260, and an exercise module 270. Some of these components may be located within the housing, while others are located outside the housing.

According to one embodiment, the second memory 230 may store at least one program or application, data, or the like associated with operating the aerial vehicle 200. According to an embodiment, the second memory 230 may store an aerial application associated with controlling an operation of moving or rotating the aerial vehicle 200 in response to control information received from an electronic device 100 of FIG. 2. The aerial application may include, for example, an instruction set associated with collecting control information provided from the electronic device 100, an instruction set to extract a movement direction, a movement speed, and operation type information from the collected control information, an instruction set to move the aerial vehicle 200 depending on the extracted information, or the like. The aerial application may also include an instruction set to receive valid range information from the electronic device 100 and propose an operation range of the aerial vehicle 200.

The second sensor 240 may collect current location information of the aerial vehicle 200. The second sensor 240 may collect altitude information of the aerial vehicle 200. The second sensor 240 may include a position sensor, an altitude sensor, and the like. The second sensor 240 may transmit the collected location and altitude information to the aerial vehicle processor 220.

The second communication circuit 260 may establish a communication channel with the electronic device 100. According to an embodiment, the second communication circuit 260 may establish a short-range communication channel (e.g., a Bluetooth communication channel) with the electronic device 100. The second communication circuit 260 may receive a pairing request signal from the electronic device 100 and may establish a Bluetooth communication channel through a pairing operation. The second communication circuit 260 may receive location information and orientation information of the electronic device 100 or valid range information from the electronic device 100. The second communication circuit 260 may receive control information associated with operation control from the electronic device 100. The second communication circuit 260 may transmit the received valid range, control information, or the like to the aerial vehicle processor 220.

The exercise module 270 may move the aerial vehicle 200 in response to a direction and speed written in the control information. The exercise module 270 may include a propeller 271, a motor 272, and an operation controller 273. The propeller 271 may include, for example, at least one or more propellers. The motor 272 may be connected with the propeller 271 and may rotate at a specified speed depending on control of the operation controller 273. The operation controller 273 may control the motor 272 and/or the propeller 271 in response to control of the aerial vehicle processor 220 to move the aerial vehicle 200 at a specified speed in a specified direction.

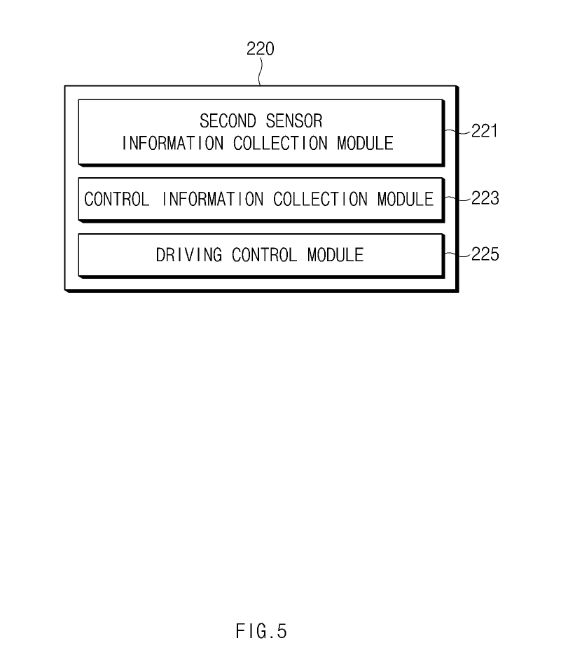

The aerial vehicle processor 220 may process a control signal associated with controlling operation of the aerial vehicle 200 or may transmit and process data. For example, the aerial vehicle processor 220 may transmit an exercise control signal to the exercise module 270 to move the aerial vehicle 200 at a specified speed in a specified direction based on the control information received from the electronic device 100. The aerial vehicle processor 220 according to an embodiment may control the aerial vehicle 200 to be operated within a valid range. The aerial vehicle processor 220 may include elements shown in FIG. 5.

FIG. 5 is a block diagram illustrating an example of a configuration of a processor of an aerial vehicle according to an embodiment of the present disclosure.

Referring to FIG. 5, an aerial vehicle processor 220 according to an embodiment of the present disclosure may include a second sensor information collection module 221, a control information collection module 223, and a driving control module 225. According to an embodiment, at least one of the second sensor information collection module 221, the control information collection module 223, and the driving control module 225 may include at least part of the aerial vehicle processor 220. Alternatively, each of the second sensor information collection module 221, the control information collection module 223, and the driving control module 225 may be implemented as a separate hardware processor and may communicate with the aerial vehicle processor 220.

According to one embodiment, the second sensor information collection module 221 may collect location information of an aerial vehicle 200 of FIG. 4. For example, the second sensor information collection module 221 may enable a GPS module (or device) and may collect current location information of the aerial vehicle 200. The second sensor information collection module 221 may enable an altitude sensor and may collect altitude information of the aerial vehicle 200. The second sensor information collection module 221 may transmit the collected location and altitude information to the driving control module 225.

The second sensor information collection module 221 may provide the collected location and altitude information of the aerial vehicle 200 to an electronic device 100 of FIG. 2 depending on user setting. The location information and the altitude information of the aerial vehicle 200, transmitted to the electronic device 100, may be used to indicate the location or the like of the aerial vehicle 200 within a valid range as visual information or audio information.

The control information collection module 223 may establish a communication channel with the electronic device 100 and may collect control information from the electronic device 100. The control information collection module 223 may extract information associated with operating the aerial vehicle 200 from the collected control information and may transmit the extracted information to the driving control module 225. The control information collection module 223 may receive valid range information from the electronic device 100 and may transmit the received valid range information to the driving control module 225. The control information collection module 223 may receive location information and orientation information of the electronic device 100 from the electronic device 100 and may transmit the location information and the orientation information to the driving control module 225.

The driving control module 225 may receive a function setting associated with operating the aerial vehicle 200. For example, the driving control module 225 may determine a setting value for a safe operation function of the aerial vehicle 200 or a setting value for a manual operation function of the aerial vehicle 200 in information received from the electronic device 100. If the safe operation function is set, the driving control module 225 may determine a valid range. The driving control module 225 may control the aerial vehicle 200 to be moved, based on control information transmitted from the electronic device 100. For example, the driving control module 225 may determine whether a movement location or a movement altitude in which the aerial vehicle 200 is moved departs from the valid range. If the aerial vehicle 200 departs from the valid range, the driving control module 225 may control the aerial vehicle 200 such that the aerial vehicle 200 does not depart from the valid range.

According to one embodiment, if receiving location information and orientation information from the electronic device 100, the driving control module 225 may determine (or verify) a setting value for a valid range (e.g., a setting value for an angle, a setting value for the shape of a valid range, a setting value for a maximum separation distance, a setting value for a movement limit range in at least one of upper and lower directions, etc.), previously stored in a second memory 230 of FIG. 4, and may calculate a valid range based on the verified setting value. The driving control module 225 may provide relative distance information or the like associated with where the aerial vehicle 200 is located in the valid range to the electronic device 100.

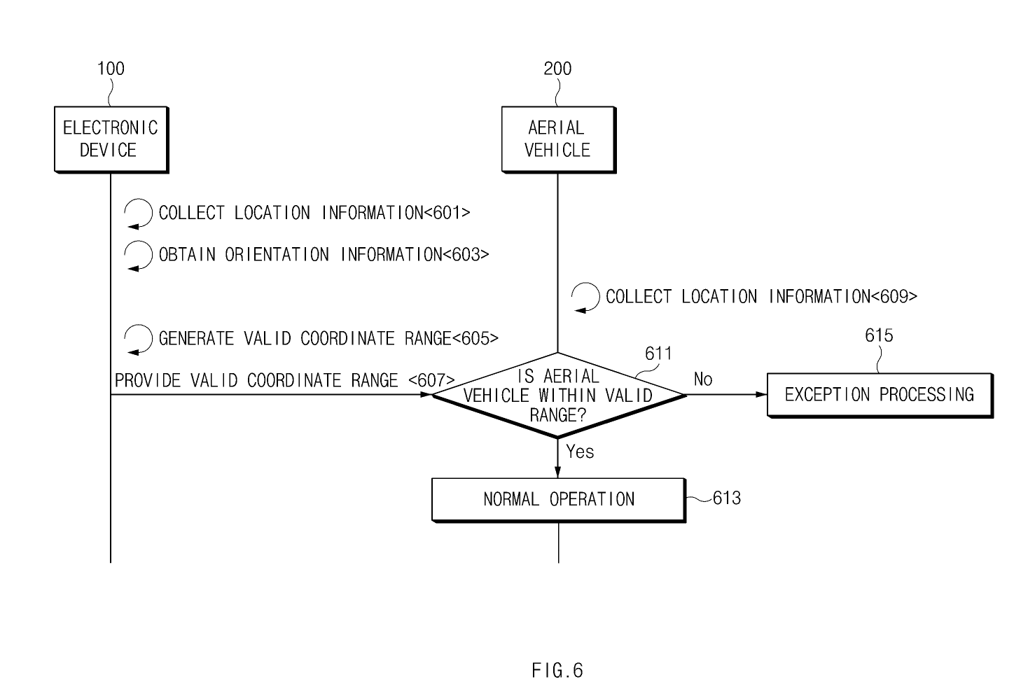

FIG. 6 is a signal sequence diagram illustrating an example of a signal flow between devices in a UAV operation environment according to an embodiment of the present disclosure.

Referring to FIG. 6, in connection with operating a UAV, in operation 601, an electronic device 100 may collect its location information. For example, the electronic device 100 may obtain its location information using a GPS or the like. In operation 603, the electronic device 100 may obtain its orientation information. For example, the electronic device 100 may collect a direction angle at which a specific portion of the electronic device 100 is oriented, using an acceleration sensor, a geomagnetic sensor, or the like. According to an embodiment, the electronic device 100 may obtain a direction angle (e.g., a left and right azimuth angle and an upper and lower altitude angle) at which a front side is oriented in a state where a user holds the electronic device 100. According to one embodiment, the electronic device 100 may adjust a valid range in response to motion or movement of a specified size or more. Likewise, the electronic device 100 may disregard motion or movement of a specified size or less so as to not change the valid range. For example, motions related to shakiness of the user's hand may be disregarded.

In operation 605, the electronic device 100 may generate a valid range. For example, the electronic device 100 may determine (or obtain) user setting information and policy information stored in a first memory 130 of FIG. 2 and may generate the valid range based on the collected location information and the collected orientation information and the obtained setting or policy information. The user setting information, the policy information, or the like may include certain angles up and down and left and right with respect to a direction in which a specific point of the electronic device 100 is oriented, a shape of a valid range, or the like.

According to one embodiment, the valid range may be ±30 degrees from left to right relative to a front direction of the electronic device 100. The valid range may be set to 90 degrees from left to right relative to the front direction of the electronic device 100 and may set to a value of 90 degrees or more in response to a user input of a user who wants the aerial vehicle 200 to fly in a wider range. The valid range may vary depending on characteristics of a corresponding location (e.g., there are many obstacles, the location may be indoors, or the like) according to an analysis of location information. In operation 607, the electronic device 100 may provide information about the valid range to the aerial vehicle 200. The electronic device 100 may transmit the valid range information to the aerial vehicle 200 based on a communication channel established between the electronic device 100 and the aerial vehicle 200.

In operation 609, the aerial vehicle 200 may collect location information of the aerial vehicle 200. The collecting of the location information may be performed, for example, after receiving a valid coordinate range from the electronic device 100. If a communication channel is established with the electronic device 100, the aerial vehicle 200 may collect its location information at constant polling intervals or in real time. According to one embodiment, the aerial vehicle 200 may collet altitude information using an altitude sensor.

In operation 611, the aerial vehicle 200 may determine whether its current location is within a valid range. For example, the aerial vehicle 200 may determine whether its location information is included in a valid range set relative to the electronic device 100. The aerial vehicle 200 may determine whether its location information is within the left and right boundaries of the valid range. The aerial vehicle 200 may determine whether its altitude information is within the upper and lower boundaries of the valid range. The aerial vehicle 200 may calculate a distance value from the electronic device 100 and may determine whether its location is within a specified distance from the electronic device 100.

If the location of the aerial vehicle 200 is within the valid range in operation 611, in operation 613, the aerial vehicle 200 may perform normal operation. The electronic device 100 may provide control information according to a use operation to the aerial vehicle 200. The aerial vehicle 200 may exercise movement in response to the received control information. If a location is changed according to control information, the aerial vehicle 200 may collect current location information and may determine whether the collected current location information is within a valid range. If currently moved location information departs from the valid range, the aerial vehicle 200 may operates to return within the valid range.

If the location of the aerial vehicle 200 is not within the valid range in operation 611, in operation 615, the aerial vehicle 200 may perform exception processing. For example, although operation control information according to a user operation is received from the electronic device 100, the aerial vehicle 200 may perform movement within the valid range in a proactive manner. For example, the aerial vehicle 200 may move and stay on a boundary of the valid range from a current location of the aerial vehicle 200. In this operation, the aerial vehicle 200 may collect its location information in real time and may compare its current location with a location within the valid range.

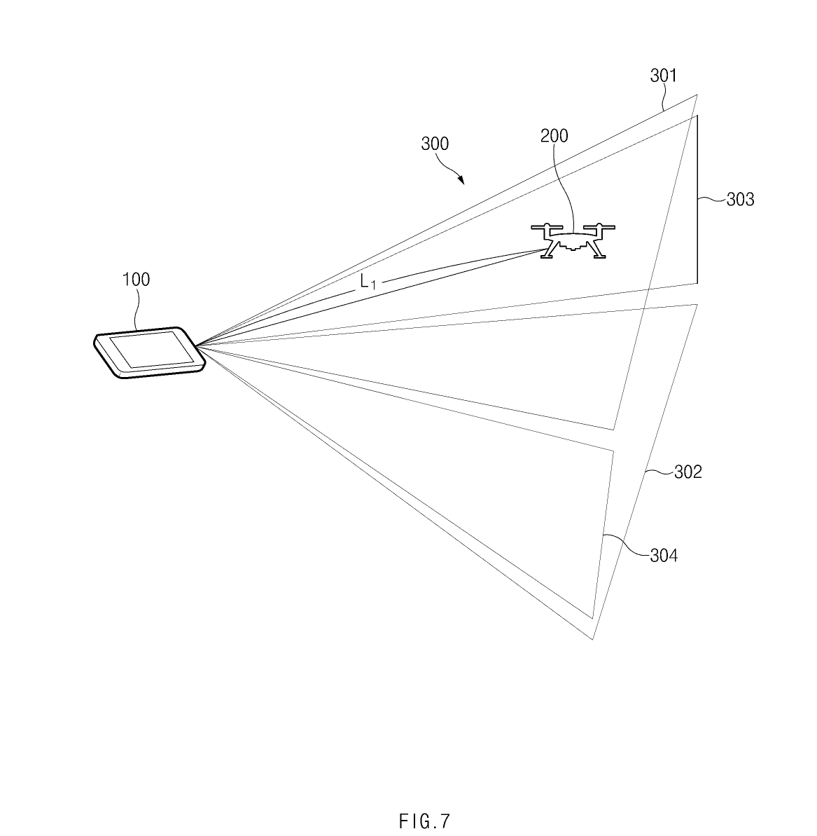

FIG. 7 is a drawing illustrating an example of a valid range according to an embodiment of the present disclosure.

Referring to FIG. 7, as shown, a valid range 200 may be implemented as a quadrangular pyramid shape at a first point of an electronic device 100. For example, the valid range 300 may include a first virtual fence 301 located at a certain angle of an upper side with respect to the first point of the electronic device 100, a second virtual fence 302 located at a certain angle of a lower side with respect to the first point of the electronic device 100, a third virtual fence 303 located at a certain angle of a left side with respect to the first point of the electronic device 100, or a fourth virtual fence 304 located at a certain angle of a right side with respect to the first point of the electronic device 100. To adjust the virtual range, the first virtual fence 301 and the second virtual fence 302 may be adjusted in angle with respect to a specified point of the electronic device 100. Similarly, the third virtual fence 303 and the fourth virtual fence 304 may be adjusted in angle with respect to the specified point of the electronic device 100. The electronic device 100 may provide a user interface for adjusting the left and right angle and the upper and lower angle.

According to one embodiment, the first virtual fence 301 and the second virtual fence 302 may be located to be horizontally symmetric relative to the specified point of the electronic device 100. The third virtual fence 303 and the fourth virtual fence 304 may be located to be vertically symmetric relative to the specified point of the electronic device 100. Alternatively, the first virtual fence 301 and the second virtual fence 302 may be asymmetrical about the specified point of the electronic device 100. For example, an angle between a horizontal surface and the first virtual fence 301 may be set to be greater than an angle between the horizontal surface and the second virtual fence 302 with respect to the horizontal surface at the specified point of the electronic device 100. According to one embodiment, the second virtual fence 302 may be located to form a horizontal angle with the specified point of the electronic device 200. Alternatively, the second virtual fence 302 may include a horizontal surface corresponding to a constant height (e.g., 2 m) from the ground to prevent collisions with persons standing below the aerial vehicle 200. An angle between the third virtual fence 303 and a vertical surface may be set to be the same as an angle between the fourth virtual fence 304. Or the angle may be different.

The electronic device 100 may include a camera. The electronic device 100 may provide the valid range 300 based on images captured by the camera. For example, a quadrangular pyramid range having four sides captured by the camera may be provided as the valid range 300. The electronic device 100 may provide the above-mentioned first to fourth virtual fences 301 to 304 based on a preview image obtained by the camera. The electronic device 100 may provide a screen interface associated with adjusting an angle of each of the first to fourth virtual fences 301 to 304. The user may adjust an angle between each of the first to fourth virtual fences 301 to 304 by adjusting an angle corresponding to each side. The electronic device 100 may provide a preview image and may adjust a portion displayed in response to adjusting an angle to show how wide the valid range 300 where the real aerial vehicle 200 will be moved according to an angle adjusted by the user is.

If an angle associated with the first virtual fence 301 is reduced relative to a horizontal line, the electronic device 100 may downwardly adjust a boundary line of the first virtual fence 301 in response to the reduced angle and may change a display state of the region that is not included in the valid range 300. For example, the electronic device 100 may blur the region outside the valid range 300 or render the region opaque. The electronic device 100 may adjust the size of the valid range 300 in response to a touch event (e.g., pinch zoom) which occurs on the display 150 where a preview image is output. Alternatively, the user may touch and drag an object corresponding to the valid range to adjust the valid range. The aerial vehicle 200 may be limited within a first distance L1 from the electronic device 100. The distance between the aerial vehicle 200 and the electronic device 100 may be changed according to a user setting.

The electronic device 100 may calculate the valid range 300 and may receive location information and altitude information of the aerial vehicle 200 from the aerial vehicle 200. The electronic device 100 may determine whether the aerial vehicle 200 is within the valid range 300 using the calculated valid range 300 and the location information and the altitude information of the aerial vehicle 200. If the aerial vehicle 200 is close to a boundary line of the valid range 300 (e.g., if the aerial vehicle 200 is located within a specified distance from the boundary line), the electronic device 100 may output a specified type of guide information (e.g., a visual or audio notification). If the aerial vehicle 200 enters within a first range with respect to the boundary line of the valid range 300, the electronic device 100 may control the aerial vehicle 200 to reduce a movement speed of the aerial vehicle 200 to a specified speed or less. If the aerial vehicle 200 enters within a second range (e.g., a specified distance nearer to the boundary line than the first range) with respect to the boundary line of the valid range 300, the electronic device 100 may control the aerial vehicle 200 to stop movement of the aerial vehicle 200 so that it hovers within the second range of the boundary line. Operation control according to a distance between the aerial vehicle 200 and the boundary may be performed based on information about the valid range 300 received from the electronic device 100 at the aerial vehicle 200.

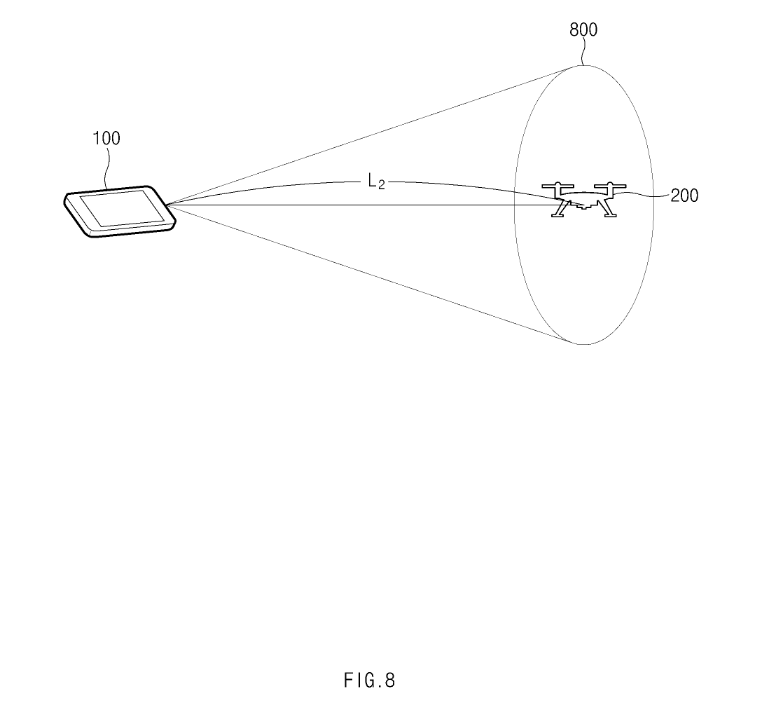

FIG. 8 is a drawing illustrating another example of a valid range according to an embodiment of the present disclosure.

Referring to FIG. 8, a valid range 800 of a conical shape may be set relative to a specified point of an electronic device 100. According to an embodiment, the valid range 800 may have a vertical section of which has a triangular shape. This triangular shape may have an upper and lower specified angles with respect to a virtual horizontal surface at the middle of the conical shape. The electronic device 100 may provide a screen interface for adjusting an angle of the triangle corresponding to the vertical section of the conical shape. The electronic device 100 may provide a screen interface for differently adjusting angles of the top and bottom triangles, where the top and bottom triangles are created by bisecting the triangle corresponding to the vertical section using the horizontal surface. A second distance L₂ between the electronic device 100 and an aerial vehicle 200 may be a maximum separation distance between the aerial vehicle 200 and the electronic device 100. The second distance L₂ may be adjusted according to a user input. The second distance L₂ may be adjusted according to an angle of a triangle corresponding to the vertical section of the conical shape. For example, if the angle of the triangle is relatively small, the second distance L₂ may be relatively large. If the angle of the triangle is relatively large, the second distance L₂ may be relatively small.

According to one embodiment, the electronic device 100 may include a camera and may display information about the valid range 800 on the display 150 using the camera. For example, the electronic device 100 may display a preview image captured by the camera on the display 150 and may display the valid range 800, in which the aerial vehicle 200 may be located, as a circle. The valid range 800 displayed as the circle may be adjusted in size in response to a user input (e.g., pinch zoom).

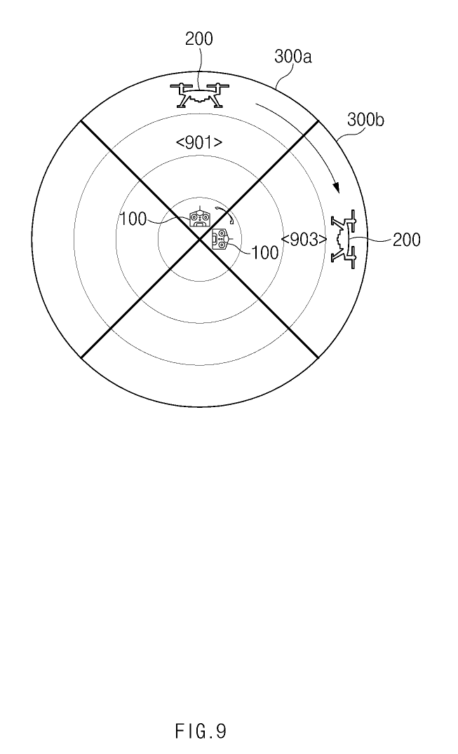

FIG. 9 is a drawing illustrating an example of a change in valid range according to an embodiment of the present disclosure.

Referring to FIG. 9, if one point of an electronic device 100 faces a first direction (e.g., an upper direction relative to the shown drawing) in state 901, a first valid range 300a may be set according to a setting. For example, a constant range of 45 degrees from left to right with respect to the vertical or a constant range corresponding to any angle between 40 degrees and 180 degrees may be set to the first valid range 300a. The electronic device 100 may provide information about the set first valid range 300a to an aerial vehicle 200. The aerial vehicle 200 may be operated within the first valid range 300a.

According to one embodiment, in state 903, the electronic device 100 may change its orientation to a second direction (e.g., a right direction with respect to the shown drawing) according to user operation. If the oriented direction is changed, the electronic device 100 may provide changed control information to the aerial vehicle 200. The aerial vehicle 200 may determine a second valid range 300b based on the control information provided from the electronic device 100 and may move to the second valid range 300b. For example, the aerial vehicle 200 may move to a location in the second valid range 300b, corresponding to a location in the first valid range 300a. For example, if the aerial vehicle 200 is located on a certain region of the center of the first valid range 300a, it may be relocated on the corresponding region of the center of the second valid range 300b. According to another embodiment, when a valid range is changed, the aerial vehicle 200 may move to a region near the boundary between the original valid region and the changed valid region (e.g., the boundary between the first valid range 300a and the second valid range 300b). If the aerial vehicle 200 is set to be disposed apart from a boundary region at a specified distance or more, the aerial vehicle 200 may move from the first valid range 300a to a location disposed apart from a boundary of the second valid range 300b by a specified distance. If a valid range is updated according to a change of direction of the electronic device 100, the aerial vehicle 200 may perform safe operation by moving to the changed valid range.

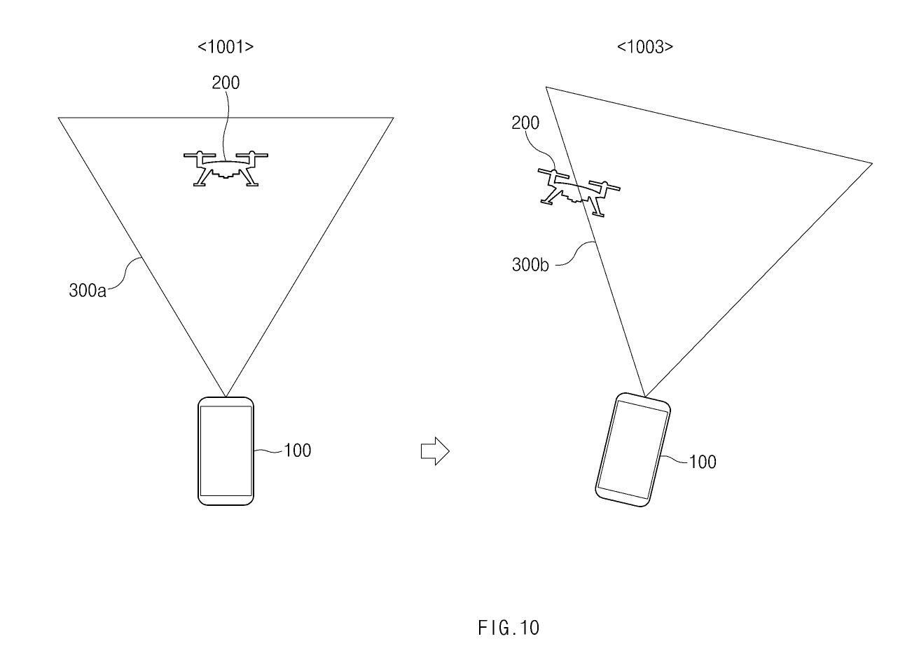

FIG. 10 is a drawing illustrating another example of a change in valid range according to an embodiment of the present disclosure.

Referring to FIG. 10, in state 1001, an aerial vehicle 200 may be operated within a first valid range 300a with respect to a specified point of an electronic device 100. For example, the aerial vehicle 200 may receive location information and orientation information from the electronic device 100 to calculate the first valid range 300a and may compare the calculated first valid range 300a with its location information. The aerial vehicle 200 may calculate a distance from the electronic device 100 and may adjust its altitude depending on the shape of the first valid range 300a. For example, as described with reference to FIG. 8 or 9, if the first valid range 300a has a shape in which the valid altitude increases as the aerial vehicle 200 moves away from the electronic device 100, the aerial vehicle 200 may move to be located within the valid range depending on the distance from the electronic device 100.

In state 1003, the direction the electronic device 100 used to set the valid range may be rotated by user operation. The first valid range 300a may be changed to a second valid range 300b depending on the rotation of the electronic device 100. The aerial vehicle 200 may compare information about the changed second valid range 300b with its location information to determine whether the aerial vehicle 200 is located within the second valid range 300b. As shown, if the aerial vehicle 200 is located at the boundary of the second valid range 300b, it may maintain its current state (e.g. its current location). If the aerial vehicle 200 is set to be disposed apart from a boundary region of the valid range at a certain distance, it may move to a location disposed apart from the left boundary of the second valid range 300b at the certain distance.

When the second valid range 300b is set, if the aerial vehicle 200 is not located in the second valid range 300b due to a rapid change of direction of the electronic device 100, the aerial vehicle 200 may move the shortest distance available to it so that it can be within the second valid range 300b. As shown, the aerial vehicle 200 may move itself to be located at the left boundary region of the second valid range 300b. And if the user continuously rotates the electronic device 100 in the same direction, the aerial vehicle 200 may move along the moved boundary region. Accordingly, the user may move the aerial vehicle 200 by simply rotating or moving the electronic device 100.

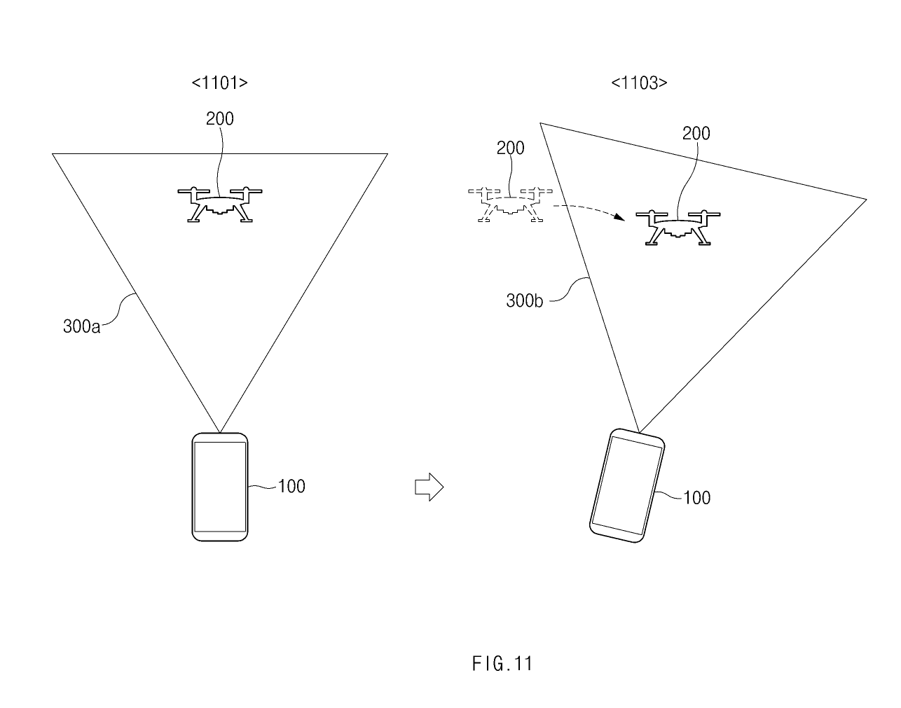

FIG. 11 is a drawing illustrating another example of a change in valid range according to an embodiment of the present disclosure.

Referring to FIG. 11, in state 1101, an aerial vehicle 200 may be operated within a first valid range 300a with respect to an electronic device 100 such that safe operation function is executed. In this state, if the first valid range 300a is changed to a second valid range 300b as a user changes the oriented direction of the electronic device 100, the aerial vehicle 200 may move within the second valid range 300b. The aerial vehicle 200 may maintain a relative location in the first valid range 300a in the second valid range 300b. For example, if the aerial vehicle 200 is located in a central portion in the first valid range 300a, it may automatically move to a central portion of the second valid range 300b. According to one embodiment, if the aerial vehicle 200 is not included in the second valid range 300b due to rapid change of the first valid range 300a, it may move within the second valid range 300b. But if the electronic device 100 changes direction gradually, the aerial vehicle 200 may move along a boundary region of a valid range.

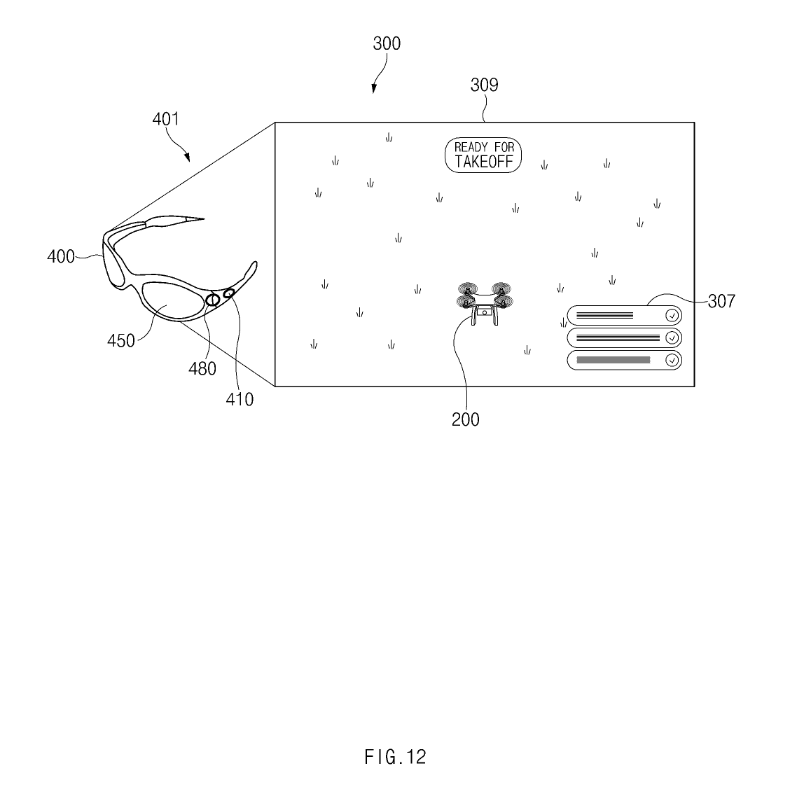

FIG. 12 is a drawing illustrating an example of operation of a valid range of an electronic device connected with a camera according to an embodiment of the present disclosure.

Referring to FIG. 12, a wearable device 400 according to one embodiment of the present disclosure may be worn by the user. The wearable device 400 may include a camera 480. The wearable device 400 may provide an augmented reality (AR) environment 401 using images captured using the camera. The AR environment 401 may include, for example, an environment in which the wearable device 400 analyzes images captured by the camera 480 and displays virtual objects 307 according to the analyzed result on the wearable display 450. Thus, while wearing the wearable device 400, the user may see both the real aerial vehicle 200 and the virtual objects 307 via the wearable display 450 having specified transparency.

In the above-mentioned environment, the wearable display 450 may display a virtual fence object 309 corresponding to a valid range 300 based on an image capture environment in which the camera 480 captures images. In the shown drawing, the virtual fence object 309 may be an object including 4 edges. The aerial vehicle 200 may be operated within the virtual fence object 309 corresponding to the valid range 300.

According to an embodiment, the wearable device 400 may further include a wearable input device 410 associated with adjusting a distance. The user may operate the wearable input device 410 to adjust a separation distance between the wearable device 400 and the aerial device 200. The wearable input device 410 may be worn close to the eyes of the user and may adjust the valid range 300 in response to a direction the user faces. The aerial vehicle 200 may move according to a change in the valid range 300 so that it is located within the changed valid range. The user may adjust a direction his or her head faces to adjust his or her view (e.g., the direction in which the wearable device 400 is oriented) as well as to adjust the movement direction and speed of the aerial vehicle 200 (e.g., by changing the valid range so that the aerial vehicle 200 moves to be within the valid range). The wearable device 400 may include, for example, an eyeglasses-type electronic device, a head mounted display (HMD), or the like.

According to an embodiment, the camera 480 included in the wearable device 400 may electrically or electronically provide an image capture screen of a similar showing the range that the user sees on the wearable display 450. The wearable device 400 may identify the aerial vehicle 200 captured by the camera 480. The wearable device 400 may generate control information for controlling the current location of the aerial vehicle 200 identified by the camera 480 within a field of view (FOV) or an image capture range of the camera 480 and may provide the generated control information to the aerial vehicle 200. According to one embodiment, if the wearable device 400 enters within a certain distance from an FOV boundary or arrives at the FOV boundary through an image analysis of the camera 480, the wearable device 400 may output a control user interface (UI) for moving the aerial vehicle 200 within the valid range 300 on the wearable display 450 or may output a notification as a specified type of guide information (e.g., at least one of a screen, an audio, or haptic feedback).

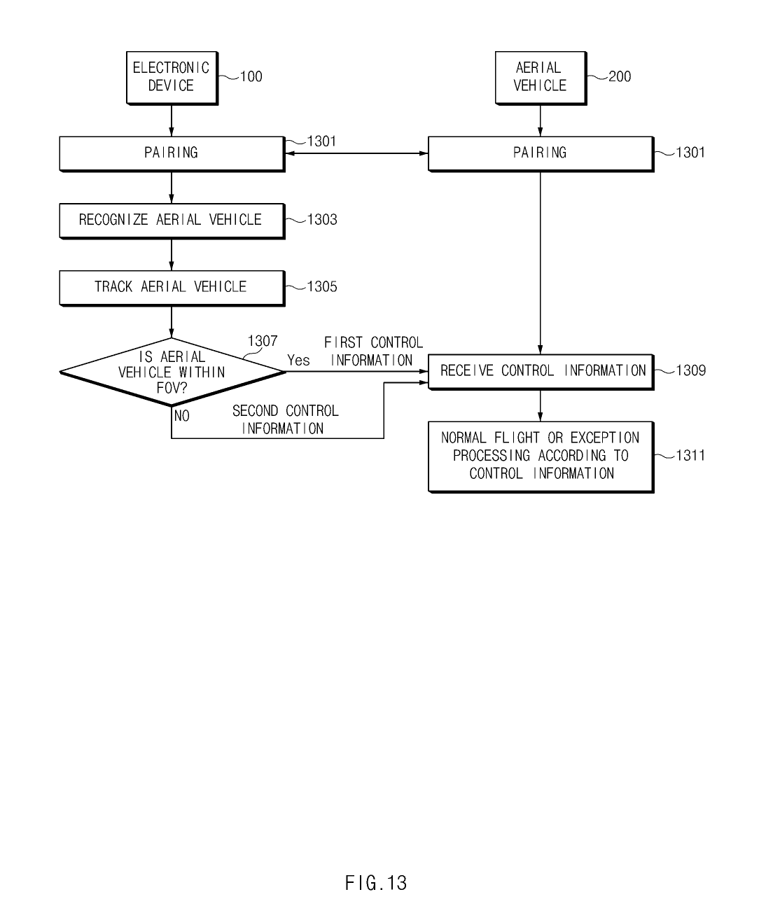

FIG. 13 is a flowchart illustrating an example of a signal flow between devices in connection with operation of a valid range of a camera-based aerial vehicle according to an embodiment of the present disclosure.

Referring to FIG. 13, in operation 1301, an electronic device 100 including a camera may perform a pairing operation with an aerial vehicle 200. For example, the electronic device 100 and the aerial vehicle 200 may include a wireless communication circuit (e.g., a short-range communication circuit, a Bluetooth communication circuit, or the like) associated with performing the pairing operation. Any one of the electronic device 100 and the aerial vehicle 200 may have a waiting state depending on user input or schedule information, and the other device may perform a pairing operation in response to a user input. After completing the pairing operation, the electronic device 100 may execute a safe operation function for setting an FOV of the camera to a valid range.

In operation 1303, the electronic device 100 may recognize the aerial vehicle 200. The electronic device 100 may capture a specified direction using the camera and may obtain a preview image for the specified direction. The electronic device 100 may analyze the obtained image to determine whether an object corresponding to the aerial vehicle 200 is detected. The electronic device 100 may store image information associated with the aerial vehicle 200 in a first memory 130 of FIG. 2. Alternatively, the electronic device 100 may receive location information and altitude information of the aerial vehicle 200 and may identify the aerial vehicle 200 in the obtained image using the received location and altitude information. In this alternative embodiment, even when there is a plurality of aerial vehicles in the capture image, the electronic device 100 may detect its paired aerial vehicle.

In operation 1305, if the aerial vehicle 200 is recognized, the electronic device 100 may perform a tracking operation. In operation 1307, the electronic device 100 may determine whether the aerial vehicle 200 is within an FOV. For example, the electronic device 100 may determine whether the aerial vehicle 200 is included in the images captured by the camera, through the analysis of the obtained images. If the aerial vehicle 200 is within the FOV, the electronic device 100 may transmit first control information to the aerial vehicle 200. If the aerial vehicle is not included in the FOV, the electronic device 100 may transmit second control information to the aerial vehicle 200.

After performing the pairing operation with the electronic device 100 in operation 1301, the aerial vehicle 200 may be operated according to reception of control information. For example, in operation 1309, the aerial vehicle 200 may receive first or second control information from the electronic device 100. In this case, in operation 1311, the aerial vehicle 200 may perform normal flight depending on control information (e.g., the first control information). The normal flight may include operation in which the aerial vehicle 200 moves at a specified speed in a specified direction, the specified speed and the specified direction being input by the user. Alternatively, in operation 1309, the aerial vehicle 200 may receive the second control information from the electronic device 100. In this case, in operation 1311, the aerial vehicle 200 may perform exception processing depending on control information (e.g., the second control information). The exception processing may include, for example, moving the aerial vehicle to be within an FOV of the camera irrespective of a specified direction and a specified speed input by the user. For example, if the aerial vehicle 200 is located in a right boundary of the FOV, it may maintain its current state even if the user input specifies movement further to the right. The electronic device 100 may inform the user that it is impossible to perform right movement of the aerial vehicle 200 or may output information for requesting to execute a manual operation function for the right movement.

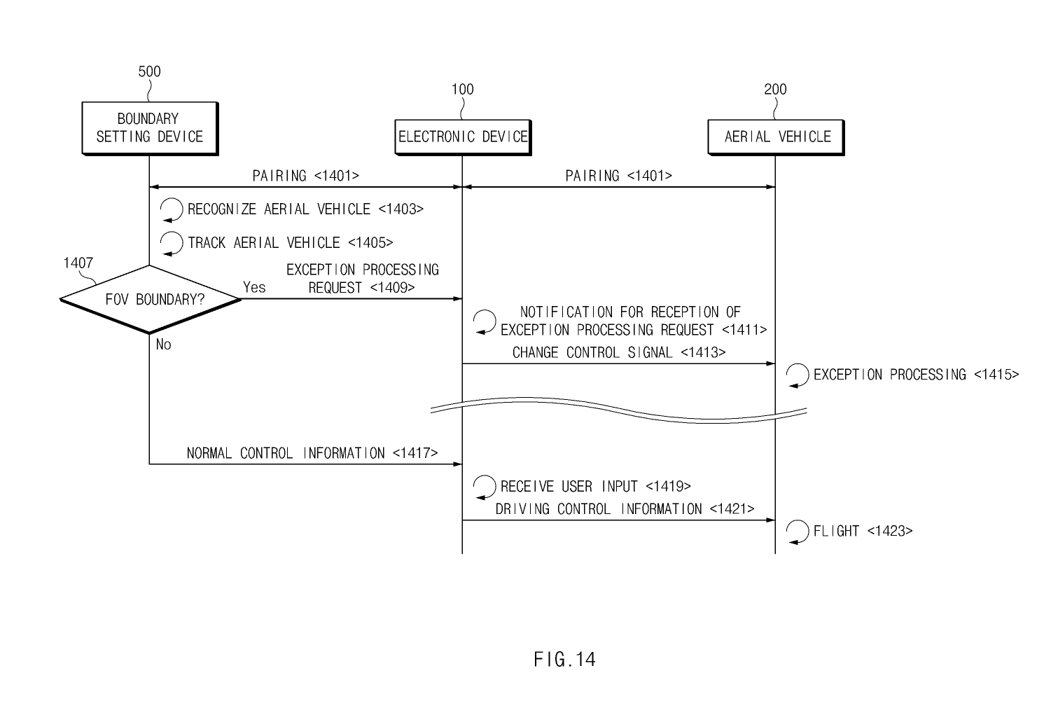

FIG. 14 is a signal sequence diagram illustrating an example of a signal flow between devices in connection with operation of a valid range based on a camera according to an embodiment of the present disclosure.

Referring to FIG. 14, a system associated with operating a valid range based on a camera may include, for example, a boundary setting device (e.g., a wearable electronic device), an electronic device 100 (e.g., an aerial vehicle controller), or an aerial vehicle 200.

In operation 1401, the boundary setting device 500 and the electronic device 100 may perform a pairing operation to establish a communication channel. The electronic device may also perform a pairing operation with the aerial vehicle 200 to establish a communication channel.

In operation 1403, the boundary setting device 500 may enable a camera in response to a user input and may analyze images (e.g., a preview image or the like) obtained by the enabled camera. The boundary setting device 500 may determine whether the aerial vehicle 200 is present in the images based on the analysis of the images. The boundary setting device 500 may previously store an image associated with the aerial vehicle 200 (or a feature points extracted from the image or a model generated based on the feature points) to recognize the aerial vehicle 200 and may compare information extracted through an analysis of the stored image with information extracted through an analysis of the currently obtained image. The boundary setting device 500 may set the FOV of the camera as the valid range.

If the aerial vehicle 200 is detected, in operation 1405, the boundary setting device 500 may track the aerial vehicle 200. For example, the boundary setting device 500 may track motion or movement of the aerial vehicle 200 in response to control by the electronic device 100.

In operation 1407, the boundary setting device 500 may determine whether motion or movement information of the aerial vehicle 200 departs from an FOV boundary. If the aerial vehicle 200 departs from the FOV boundary of the camera, in operation 1409, the boundary setting device 500 may transmit an exception processing request to the electronic device 100. The boundary setting device 500 may provide information about the valid range and location information of the aerial vehicle 200 to the electronic device 100.

If receiving the exception processing request from the boundary setting device 500 in operation 1409, in operation 1411, the electronic device 100 may output a notification for the reception of the exception processing request. According to an embodiment, the electronic device 100 may output visual information associated with the reception of the exception processing request on a display 150 of FIG. 2 or may provide auditory feedback to inform the user of the reception of the exception processing request. The electronic device 100 may also output haptic feedback of a specified pattern according to occurrence of the exception processing request.

In operation 1413, the electronic device 100 may transmit a change control signal associated with exception processing to the aerial vehicle 200. The change control signal may include, for example, driving control information for moving the aerial vehicle 200 within the FOV If receiving the change control signal from the electronic device 100, in operation 1415, the aerial vehicle 200 may perform an operation for moving the aerial vehicle 200 within the FOV The aerial vehicle 200 may control movement from a current location to the closest point in an FOV region.

If the aerial vehicle 200 does not depart from the FOV boundary in operation 1407, in operation 1417, the boundary setting device 500 may transmit normal control information to the electronic device 100. If receiving the normal control information from the boundary setting device 500, in operation 1419, the electronic device 100 may receive a user input. The user input may include, for example, an input for moving the aerial vehicle 200 in a certain direction. In operation 1421, the electronic device 100 may generate driving control information according to the user input and may transmit the generated driving control information to the aerial vehicle 200. In operation 1423, the aerial vehicle 200 may perform flight depending on the received driving control information. For example, the aerial vehicle 200 may operate its motor to move itself in the certain direction specified by the user.

If the user wears an eyeglasses electronic device (e.g., the boundary setting device 500) including a camera or the like and operates a controller (e.g., the electronic device 100) for controlling the aerial vehicle 200, a valid range operation system according to an embodiment of the present disclosure may ensure safe operations of the aerial vehicle 200 by limiting a motion or movement range of the aerial vehicle 200 using the eyeglasses electronic device while operating the aerial vehicle 200.

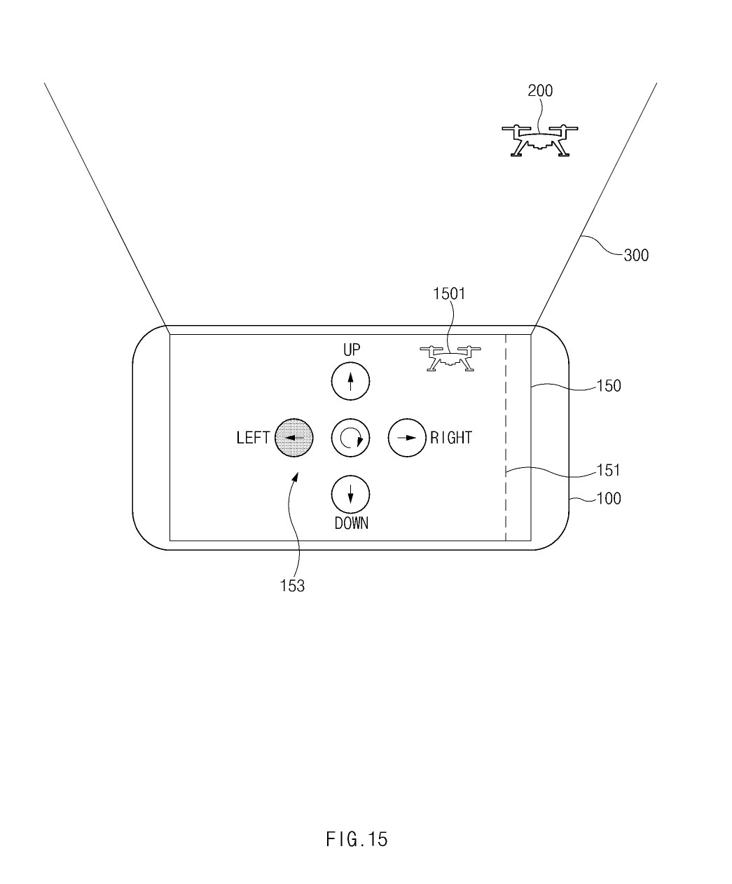

FIG. 15 is a drawing illustrating an example of a screen interface associated with operation of a valid range according to an embodiment of the present disclosure.

Referring to FIG. 15, an electronic device 100 may include a display 150 and may display an aerial vehicle 200 on the display 150. The aerial vehicle 200 may move in the valid range 300 and, as shown, may move to an area adjacent to a right boundary of the valid range 300. In this case, as shown, the display 150 may display a boundary line object 151 corresponding to the right boundary line of the valid range 300. The display 150 may display a virtual aerial vehicle 1501 corresponding to the aerial vehicle 200 on the display 150.

If the virtual aerial vehicle 1501 is approached to the boundary line object 151 (e.g., a right boundary line object) within a specified distance, the electronic device 100 according to an embodiment of the present disclosure may output a control UI 153 so that the user can control the aerial vehicle 200 to stay within the valid range 300. The control UI 153 may include a control object (e.g., left, right, up, down, rotation, or the like) for each direction. The control object in the control UI 153 that may be used to control the aerial vehicle 200 to stay within the valid range 300 may be displayed to be different from the other control objects. For example, as shown in the figure, the left control object, which can be used to control the aerial vehicle 200 to move away from the boundary line object 151, may be highlighted.

If receiving a user input signal according to an operation of the control UI 153, the electronic device 100 may determine whether the received user input is an input for moving the aerial vehicle 200 away from a boundary line. If so, the electronic device 100 may transmit the control information to the aerial vehicle 200. On the other hand, if receiving an input for moving close to the boundary line object 151 or crossing the boundary line object 151, the electronic device 100 may inform a user of invalidity of the input and may output guide information for requesting a specified direction instead (e.g., left movement of the aerial vehicle 200).

According to an embodiment, an image output on the display 150 may be an image obtained by a camera included in the electronic device 100 or an image captured by a camera of a wearable electronic device worn by the user. If an image capture angle of the camera is changed according to motion or movement of the wearable electronic device, the display 150 may output an image collected at the changed image capture angle of the camera. If the aerial vehicle 200 moves in a direction to cross a boundary line of the valid range 300 or if the aerial vehicle 200 departs from an FOV of the camera, the electronic device 100 may automatically control the aerial vehicle 200 to move the aerial vehicle 200 to stay within a specified distance of the crossed boundary line. For example, the aerial vehicle 200 may depart from the valid range 300 irrespective of intention of the user due to environmental factors, such as wind or inertial motion. In this case, if the aerial vehicle 200 crosses a boundary line of the valid range 300, the electronic device 100 may generate control information for moving the aerial vehicle 200 to be within a specified distance of the boundary line and may provide the generated control information to the aerial vehicle 200. The aerial vehicle 200 may accordingly move to be within the specified distance of the boundary line of the valid range 300.

The display 150 may display the virtual aerial vehicle 1501 corresponding to the aerial vehicle 200 and a range object corresponding to a boundary of the valid range 300. If the user touches and drags the virtual aerial vehicle 1501 to perform an operation of moving the virtual aerial vehicle 1501 within the range object, the electronic device 100 may automatically generate control information corresponding to the touch operation and may provide the control information to the aerial vehicle 200.

According to one embodiment, an electronic device may include at least one camera, and an FOV of the camera may define the valid range in which the aerial vehicle 200 may be operated. The electronic device 100 may obtain location information of the at least one camera, information about the direction the camera faces or the FOV of the camera, and may set the valid range based on the obtained information. The electronic device 100 may obtain FOVs of a plurality of cameras and location information of the plurality of cameras and may output a selection UI for selecting a camera. The user may select a specified camera on the selected UI, and the electronic device 100 may provide the obtained information to the aerial vehicle 200. The aerial vehicle 200 may determine its location information and may automatically move within the FOV corresponding to the camera based on the location information and the FOV information of the camera. According to one embodiment, the aerial vehicle 200 may include a proximity sensor. If a collision with an obstacle around the aerial vehicle 200 is predicted, the aerial vehicle 200 may stop moving.

The at least one camera may be located indoors. The camera may include, for example, an internet protocol (IP) camera or the like. The camera located indoors may provide FOV information to the electronic device 100. The electronic device 100 may set the FOV of the camera as the valid range, and the aerial vehicle 200 may be operated within the FOV of the camera. The aerial vehicle 200 may detect proximity using the proximity sensor. If the aerial vehicle 200 is approaching within a certain distance from an indoor structure, it may stop moving or may hover. The electronic device 100 may output information associated with the FOV of the connected camera on the display 150 and may adjust shape, size, angles, or the like of the FOV in response to a user operation.

According to one embodiment, an electronic device is provided. The electronic device may include a housing, a display, at least one first sensor located in the housing and configured to generate first data associated with an orientation of the housing, a second sensor located in the housing and configured to generate second data associated with a location of the housing, a wireless communication circuit located in the housing, a processor located in the housing and electrically connected with the display, the at least one first sensor, the second sensor, and the wireless communication circuit, and a memory located in the housing, wherein the memory stores instructions, when executed, cause the processor to establish a wireless communication channel with an unmanned aerial vehicle (UAV) via the wireless communication circuit, receive the first data from the at least one first sensor, obtain the orientation of the housing based on at least part of the received first data, receive the second data from the second sensor, obtain the location of the housing based on at least part of the received second data, based on the orientation and/or the location, determine a valid range in which the UAV can operate, and transmit a control signal to the UAV via the wireless communication circuit, where the control signal is executed by the UAV such that the UAV stays within in the valid range.

According to one embodiment, the valid range may be in a quadrangular pyramid shape.

According to one embodiment, the quadrangular pyramid shape may include a vertex adjacent to the housing.

According to one embodiment, the valid range may be in a conical shape extending from the electronic device to the UAV, the conical shape may be defined by a vertex adjacent to the housing, and a first virtual line and a second virtual line extending from the electronic device to the UAV. At the vertex, the first virtual line may form an angle with the second virtual line.

According to one embodiment, the angle may be an acute angle.

According to one embodiment, the angle may be in a range of 40 degrees to 180 degrees.

According to one embodiment, the control signal may be executed by the UAV such that the UAV moves to be within a specified distance of a boundary of the valid range.

According to one embodiment, an electronic device is provided. The electronic device may include a communication circuit configured to establish a communication channel with an aerial vehicle, a sensor configured to collect location information and orientation information, a memory configured to store an application associated with controlling the aerial vehicle, and a processor electrically connected with the communication circuit, the sensor, and the memory. The processor may be configured to calculate a valid range defining a space where it is possible to operate the aerial vehicle, based on location and/or orientation information of the electronic device.

According to one embodiment, the processor may be configured to obtain a setting value stored in the memory and adjust at least one of a size of the valid range and a shape of the valid range depending on the obtained setting value.

According to one embodiment, the shape of the valid range may be a quadrangular pyramid or a cone.

According to one embodiment, a distance between the valid range and the ground may be equal to or greater than a predetermine value.

According to one embodiment, the processor may be configured to if at least one of the location or the orientation of the electronic device is changed, recalculate a changed valid range in response to the changed location or orientation and transmit information about the changed valid range to the aerial vehicle.

According to one embodiment, the electronic device may further include a camera configured to obtain an image in an image capture angle, and the processor may be configured to set a field of view (FOV) of the camera to the valid range.

According to one embodiment, the electronic device may further include a display, wherein the processor may be configured to output a virtual object indicating the valid range on the display.

According to one embodiment, the processor may be configured to collect location information of the aerial vehicle, determine whether the aerial vehicle is within the valid range, if the aerial vehicle is outside the valid range, automatically generate control information such that the aerial vehicle moves to be within the valid range and transmit the control information to the aerial vehicle.

According to one embodiment, the processor may be configured to transmit valid range information calculated in real time according to current location and/or orientation information to the aerial vehicle.

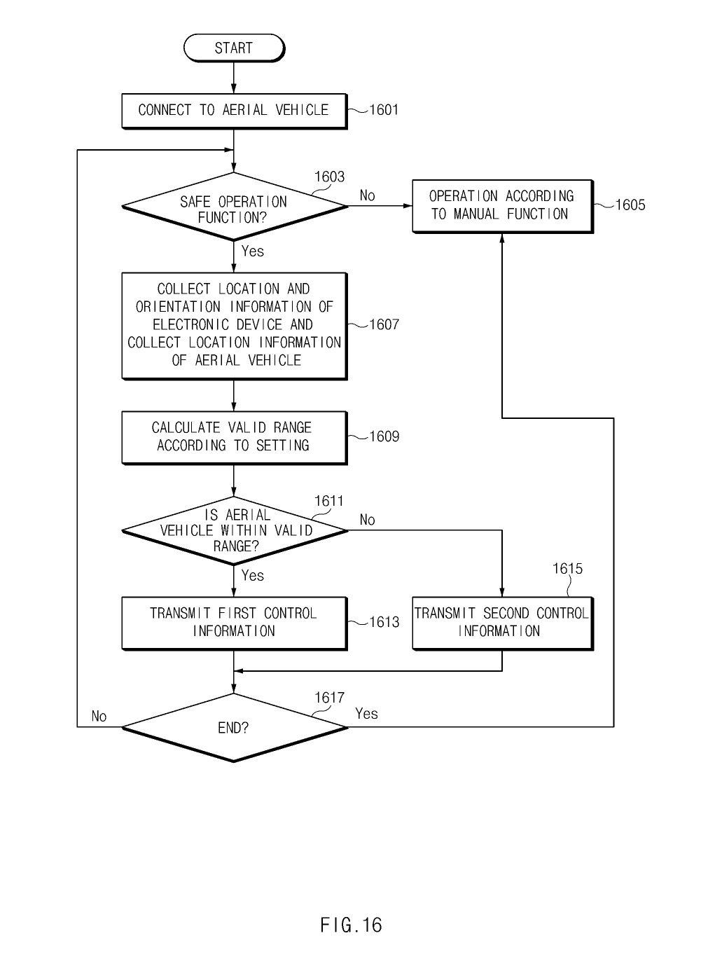

FIG. 16 is a flowchart illustrating an example of an operation method of an electronic device associated with operating a UAV according to an embodiment of the present disclosure.

Referring to FIG. 16, in connection with operating the UAV, in operation 1601, an electronic device 100 of FIG. 1 may be connected with an aerial vehicle 200 of FIG. 1. For example, the electronic device 100 may perform a pairing operation with the aerial vehicle 200 in response to a user input.

In operation 1603, if an event is generated, the electronic device 100 may determine whether the generated event is an event associated with a safe operation function. For example, the electronic device 100 may determine whether there is a setting associated with the safe operation function or whether there is a user input for requesting to execute the safe operation function. If the generated event is not the safe operation function, in operation 1605, the electronic device 100 may control operation according to manual function. For example, if a manual operation function is set, the electronic device 100 may generate control information according to a user input and may provide the generated control information to the aerial vehicle 200. The aerial vehicle 200 may fly according to the control information.

In operation 1607, the electronic device 100 may collect its location and orientation information and may collect location information of the aerial vehicle 200. The electronic device 100 may enable a position sensor, an acceleration sensor, and the like and may collect the location information and the orientation information. The electronic device 100 may request the aerial vehicle 200 to transmit the location information of the aerial vehicle 200. The electronic device 100 may collect altitude information of the aerial vehicle 200. According to one embodiment, collection of at least one of location information and altitude information of the aerial vehicle 200 may be performed after operation 1609.

In operation 1609, the electronic device 100 may calculate a valid range according to one or more settings. For example, the electronic device 100 may determine (or obtain information of) an angle range, an area range, a space range, or the like for a specified direction with respect to the electronic device 100. The setting may include, for example, an angle value for a certain direction with respect to a certain point of the electronic device 100. The setting may include, for example, a shape of the valid range. The setting may include, for example, a maximum separation distance between the aerial vehicle 200 and the electronic device 100.

In operation 1611, the electronic device 100 may determine whether the aerial vehicle 200 is within the valid range. In this regard, the electronic device 100 may determine whether the location information of the aerial vehicle 200 is within the valid range. If the valid range includes a valid altitude, the electronic device 100 may determine whether an altitude of the aerial vehicle 200 is within the valid altitude. For example, the valid altitude threshold may be lower when the aerial vehicle 200 is closer to the electronic device 100 and may be higher when the aerial vehicle 200 is farther away from the electronic device 100. According to another embodiment, the valid altitude may be set to be identical (e.g., a height of 2 m or more) irrespective of the separation distance from the electronic device 100.

If the aerial vehicle 200 is within the valid range, in operation 1613, the electronic device 100 may transmit first control information to the aerial vehicle 200. The first control information may include, for example, direction, distance, or speed information for moving the aerial vehicle 200 depending on a user input. If the aerial vehicle 200 is out of the valid range, in operation 1615, the electronic device 100 may transmit second control information to the aerial vehicle 200. The second control information may include, for example, information such as a movement direction, distance, or speed for stopping the aerial vehicle 200 or moving the aerial vehicle 200 to a specified point of a valid range (e.g., a boundary line of the valid range).

In operation 1617, the electronic device 100 may determine whether an event associated with ending the safe operation function or ending an operation function of the aerial vehicle 200 occurs. If the event associated with ending the function does not occur, the electronic device 100 may branch to operation 1603 to perform the operations again from operation 1603. When the event associated with ending the safe operation function occurs, the electronic device 100 may branch to operation 1605 to control operation of the aerial vehicle 200 according to the manual function. According to various embodiments, If the event associated with ending the operation function of the aerial vehicle 200 occurs, the electronic device 100 may transmit a control signal to the aerial vehicle 200, the control signal includes movement direction, distance, and coordinate information to return the aerial vehicle 200 to a specified point (e.g., a point where the aerial vehicle 200 is initially started)

In the above description, an embodiment is exemplified as the electronic device 100 verifies operation within a valid range of the aerial vehicle 200 and performs operations associated with controlling the aerial vehicle 200. But the present disclosure is not so limited. For example, the electronic device 100 may collect only its location and orientation information in connection with calculating the valid range and may provide the collected information to the aerial vehicle 200. If location information and orientation information of the electronic device 100 are changed, the electronic device 100 may transmit the changed location information and orientation information to the aerial vehicle 200 to update the valid range. The electronic device 100 may calculate a valid range and may provide information about the calculated valid range to the aerial vehicle 200. If at least one of location information and orientation information of the electronic device 100 is changed, the electronic device 100 may calculate a changed valid range again and may provide information about the changed valid range to the aerial vehicle 200.

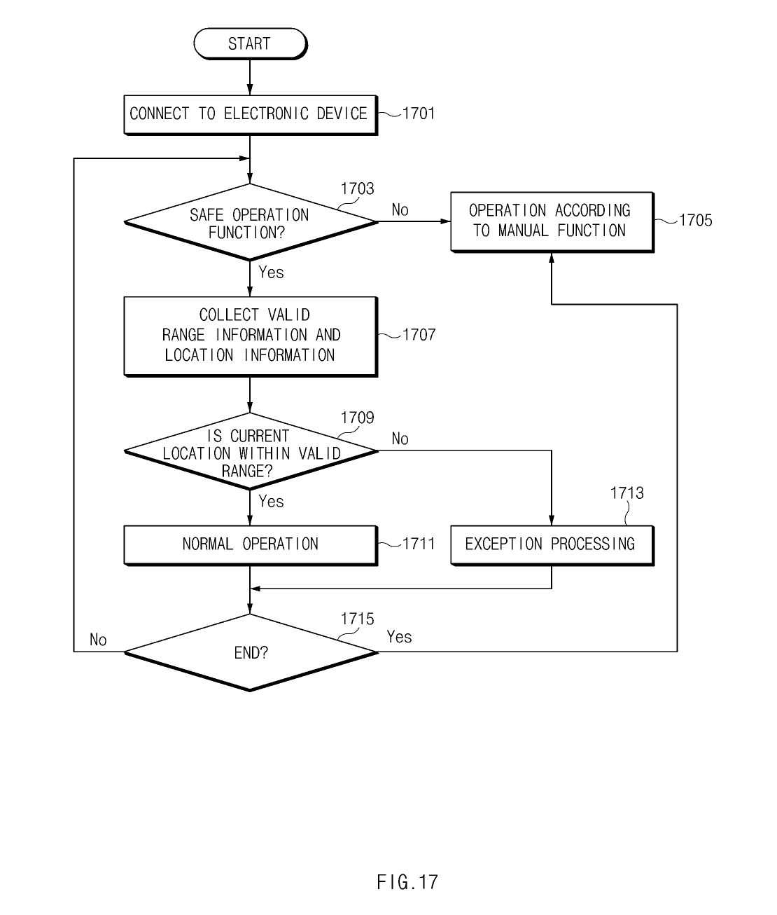

FIG. 17 is a flowchart illustrating an example of an operation method of an aerial vehicle associated with operating a UAV according to an embodiment of the present disclosure.

Referring to FIG. 17, in connection with operating the UAV, in operation 1701, an aerial vehicle 200 of FIG. 1 may be connected with an electronic device 100 of FIG. 1. For example, the aerial vehicle 200 may be in a connection waiting state and may be paired with the electronic device 100 in response to a pairing connection request from the electronic device 100. In operation 1703, the aerial vehicle 200 may determine whether there is a safe operation function setting or whether there is a user input for requesting to execute a safe operation function. If there is no the safe operation function setting or the user input, in operation 1705, the aerial vehicle 200 may control operation according to its manual function or manual mode. For example, the aerial vehicle 200 may move at a specified direction, distance, or speed based on control information received from the electronic device 100 in its default manual mode.

If there is the setting associated with the safe operation function or if the user input occurs in operation 1703, in operation 1707, the aerial vehicle 200 may collect valid range information and location information. According to an embodiment, the aerial vehicle 200 may receive the valid range information from the electronic device 100. Alternatively, the aerial vehicle 200 may receive location information and orientation information of the electronic device 100 and a setting value associated with a valid range from the electronic device 100. The aerial vehicle 200 may then calculate a valid range based on the received location and orientation information of the electronic device 100 and/or the setting value associated with the valid range. The aerial vehicle 200 may also collect its own location and altitude information using the appropriate location and altitude sensors.

In operation 1709, the aerial vehicle 200 may determine whether its current location is within the valid range. If the aerial vehicle 200 is within the valid range, in operation 1711, the aerial vehicle 200 may perform normal operation. For example, the aerial vehicle 200 may move in an input direction by an input distance or may move at an input speed, in response to a user input included in control information transmitted from the electronic device 100.

If the aerial vehicle 200 is out of the valid range in operation 1709, in operation 1713, the aerial vehicle 200 may perform exception processing. For example, the aerial vehicle 200 may automatically move to a specified point in the valid range (e.g., a boundary line of the valid range). While performing this operation, the aerial vehicle 200 may determine whether control information received from the electronic device 100 will result in the aerial vehicle 200 being placed outside the valid range. If so, the aerial vehicle 200 may disregard the control information.

In operation 1715, the aerial vehicle 200 may determine whether an event associated with ending a safe operation function is received. Upon ending the safe operation function, the aerial vehicle 200 may end operation in the valid range. The aerial vehicle 200 may branch to operation 1705 and execute the manual operation function after safe operation function is ended and may perform an operation according to a user input of the electronic device 100. If the event associated with ending the safe operation function is not received, the aerial vehicle 200 may branch to operation 1703 to perform the operations again from operation 1703.

Various embodiments of the present disclosure may provide a method for performing safe flight control of a UAV within a specified valid range without requiring the user to depart from his or her view when operating the UAV using an electronic device (e.g., a controller, a wearable device, or the like). Various embodiments of the present disclosure may manage the valid range of the electronic device to be similar to the FOV of the user, such that the UAV does not leave the user's view. Embodiments of the present disclosure may dynamically change the valid range depending on the location/orientation of the electronic device so that the UAV can be more easily operated.

According to one embodiment, a method for controlling operation of a UAV is provided. The method may include establishing, by an electronic device, a communication channel with the UAV, collecting, by the electronic device, location information and orientation information of the electronic device, calculating, by the electronic device, a valid range defining a space where it is possible to operate the UAV, based on the collected location and/or orientation information of the electronic device, collecting, by the electronic device, location information of the UAV, determining, by the electronic device, whether the UAV is within the valid range and transmitting, by the electronic device, control information associated with operating the UAV to the UAV as a result of the determination.

According to one embodiment, the transmitting may include, if the UAV is outside the valid range, automatically generating the control information, wherein the control information is for moving the UAV to be within the valid range.

According to one embodiment, the transmitting may include collecting a user input through the electronic device while the UAV is within the valid range and generating the control information in response to the user input, wherein the control information is for moving the UAV to a specified distance at a specified speed in a specified direction.

According to one embodiment, the calculating may include obtaining a setting value stored in a memory of the electronic device and adjusting at least one of a size of the valid range and a shape of the valid range depending on the obtained setting value.

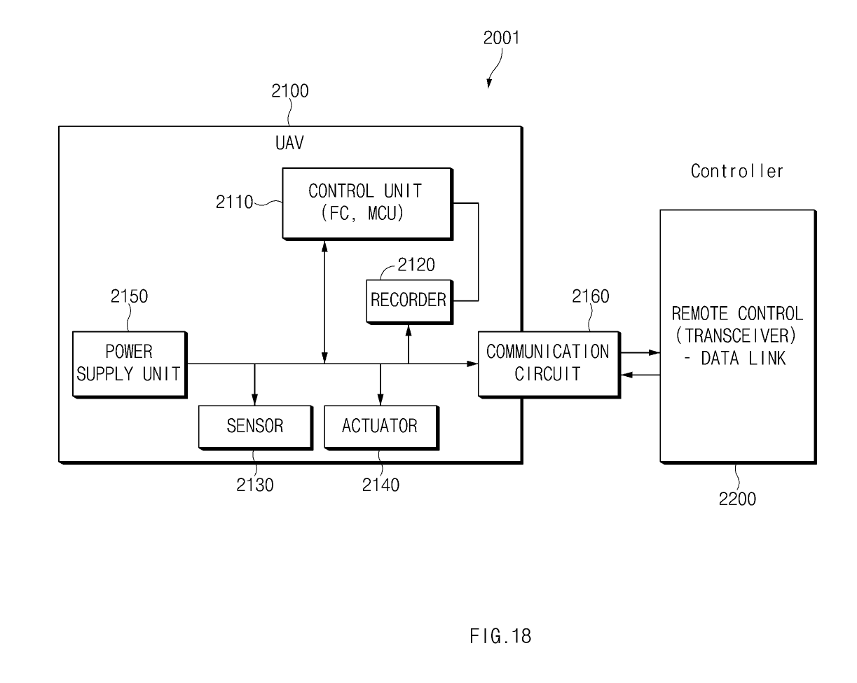

FIG. 18 illustrates an example of an unmanned aerial vehicle and a remote controller according to an embodiment of the present disclosure.

Referring to FIG. 18, an unmanned aerial vehicle 2001 according to an embodiment of the present disclosure may include a body 2100, a control unit 2110, a power supply unit 2150, a sensor 2130, an actuator 2140, a communication circuit 2160, and a recorder 2120. As described above, the body 2100 may include a housing in which a drive device (e.g., a PCB having the control unit 2110, the power supply unit 2150, and the communication circuit 2160 mounted thereon) is mounted and a support for fixing the actuator 2140 or the sensor 2130. The power supply unit 2150 may include, for example, the above-described battery of battery pack. The sensor 2130 may include the above-described sensor 30, the actuator 2140 may include the above-described motors 40, and the recorder 2120 may include, for example, the camera 20 and a memory device for storing images obtained by the camera 20.

The remote controller 2200 according to an embodiment of the present disclosure may include a communication unit for communicating with the unmanned aerial vehicle 2001, an input unit for controlling a change of the direction of the unmanned aerial vehicle 2001 upwards, downwards, leftwards, rightwards, forwards, or backwards, and a control unit for controlling a camera mounted on the unmanned aerial vehicle 2001. In this regard, the remote controller 2200 may include a communication circuit, a joystick, a touch panel, or the like. Additionally, the remote controller 2200 may include a display for outputting images taken by the unmanned aerial vehicle 2001 in real time.

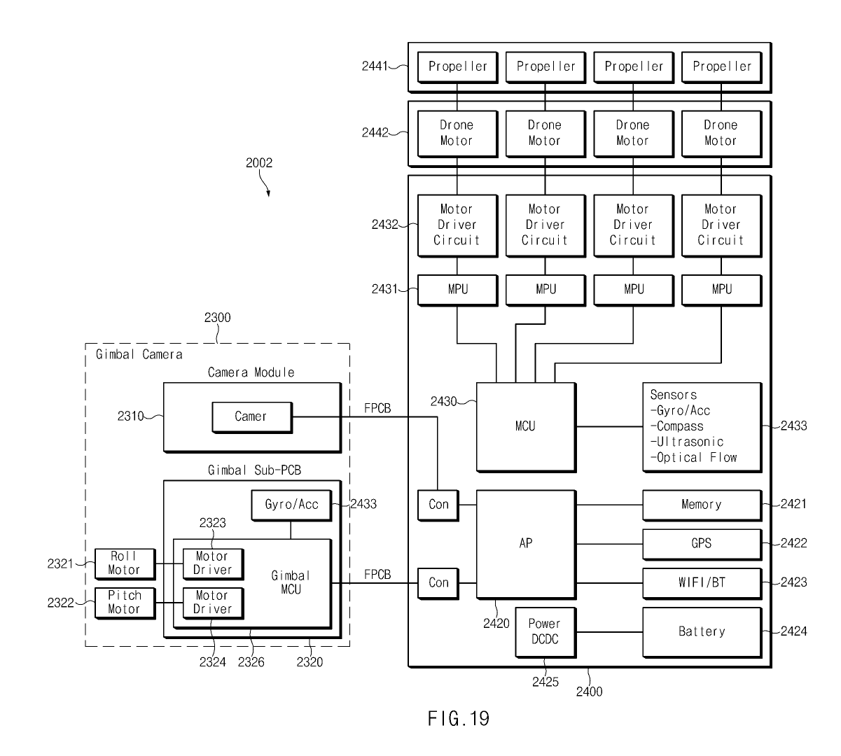

FIG. 19 illustrates an example of an unmanned aerial vehicle according to an embodiment of the present disclosure.

Referring to FIG. 19, an unmanned aerial vehicle 2002 according to an embodiment of the present disclosure may include a gimbal camera device 2300, a drive device 2400, a plurality of propellers 2441, and a plurality of motors 2442.

The gimbal camera device 2300 according to an embodiment of the present disclosure may include, for example, a camera module 2310, a gimbal sub-PCB 2320, a roll motor 2321, and a pitch motor 2322. The gimbal sub-PCB 2320 may include a gyro sensor and an acceleration sensor 2325 and a gimbal motor control circuit 2326, and the gimbal motor control circuit 2326 may include a first motor driver 2323 for controlling the roll motor 2321 and a second motor driver 2324 for controlling the pitch motor 2322.

The drive device 2400 according to an embodiment of the present disclosure may include an application processor 2420 and a main motor control circuit 2430. Furthermore, the drive device 2400 may include a memory 2421, a position information collecting sensor 2422 (e.g., a GPS), and a communication circuit 2423 (e.g., Wi-Fi or BT) that are controlled by the application processor 2420.

The drive device 2400 according to an embodiment of the present disclosure may include at least one sensor 2433 controlled by the main motor control circuit 2430, a plurality of motor driver circuits 2432 for controlling the plurality of motors 2422, and a plurality of sub-motor control circuits 2431 for controlling the plurality of motor driver circuits 2432. The drive device 2400 may include a battery 2424 and a power control unit 2425.

The gimbal camera device 2300 and the drive device 2400, according to an embodiment of the present disclosure, may be connected together through a flexible printed circuit board (FPCB) or a conducting wire.

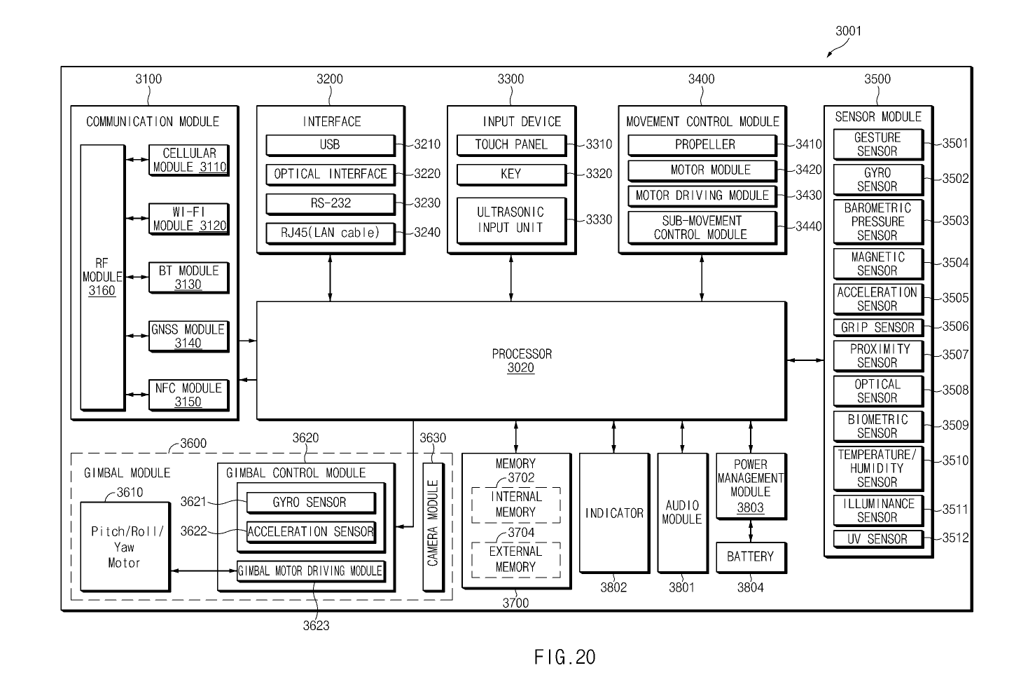

FIG. 20 illustrates another example of an unmanned aerial vehicle according to an embodiment of the present disclosure.

Referring to FIG. 20, an unmanned aerial vehicle 3001 may include at least one processor 3020 (e.g., an AP), a communication module 3100, an interface 3200, an input device 3300, a sensor module 3500, a memory 3700, an audio module 3801, an indicator 3802, a power management module 3803, a battery 3804, a camera module 3630, and a movement control module 3400, and may further include a gimbal module 3600.

The processor 3020 according to an embodiment of the present disclosure may drive, for example, an operating system or application programs to control a plurality of hardware or software elements connected to the processor 3020 and to process and compute a variety of data. The processor 3020 may generate flight commands of the unmanned aerial vehicle 3001 by driving the operating system or an application program. For example, the processor 3020 may generate a movement command by using data received from the camera module 3630, the sensor module 3500, or the communication module 3100. The processor 3020 may generate a movement command by computing a relative distance of an obtained subject, may generate an altitude movement command of an unmanned photographing device with the vertical coordinate of the subject, and may generate a horizontal and azimuth angle command of the unmanned photographing device with the horizontal coordinate of the subject.

The communication module 3100 according to an embodiment of the present disclosure may include, for example, a cellular module 3110, a Wi-Fi module 3120, a Bluetooth module 3130, a global navigation satellite system (GNSS) module 3140, an NFC module 3150, and an RF module 3160. The communication module 3100 according to various embodiments of the present disclosure may receive a control signal for the unmanned aerial vehicle 3001 and may transmit status information of the unmanned aerial vehicle 3001 and image data information to another electronic device. The RF module 3160 may transmit and receive a communication signal (e.g., an RF signal). The RF module 3160 may include, for example, a transceiver, a power amplifier module (PAM), a frequency filter, a low noise amplifier (LNA), an antenna, or the like. The GNSS module 3140 may output position information, such as latitude, longitude, altitude, GPS speed, GPS heading, and the like, while the unmanned aerial vehicle 3001 moves. The position information may be computed by measuring accurate time and distance through the GNSS module 3140. The GNSS module 3140 may also obtain accurate time together with three-dimensional speed information, as well as latitude, longitude, and altitude. The unmanned aerial vehicle 3001 according to an embodiment may transmit information for checking a real-time moving state of the unmanned photographing device to an external electronic device (e.g., a portable terminal capable of communicating with the unmanned aerial vehicle 3001) through the communication module 3100.

The interface 3200 according to an embodiment of the present disclosure may be a device for input/output of data with another electronic device. The interface 3200 may forward commands or data input from another external device to other element(s) of the unmanned aerial vehicle 3001 by using, for example, a USB 3210, an optical interface 3220, an RS-232 3230, or an RJ45 3240. Alternatively, the interface 3200 may output commands or data received from the other element(s) of the unmanned aerial vehicle 3001 to a user or the other external device.

The input device 3300 according to an embodiment of the present disclosure may include, for example, a touch panel 3310, a key 3320, and an ultrasonic input device 3330. The touch panel 3310 may use at least one of, for example, capacitive, resistive, infrared and ultrasonic detecting methods. Also, the touch panel 3310 may further include a control circuit. The key 3320 may include, for example, a physical button, an optical key, or a keypad. The ultrasonic input device 3330 may sense ultrasonic waves, which are generated from an input device, through a microphone and may check data corresponding to the sensed ultrasonic waves. A control input of the unmanned aerial vehicle 3001 may be received through the input device 3300. For example, if a physical power key is pressed, the power supply of the unmanned aerial vehicle 3001 may be shut off.

The sensor module 3500 according to an embodiment of the present disclosure may include some or all of a gesture sensor 3501 for sensing a motion and/or gesture of a subject, a gyro sensor 3502 for measuring the angular velocity of an unmanned photographing device in flight, a barometric pressure sensor 3503 for measuring an atmospheric pressure change and/or atmospheric pressure, a magnetic sensor 3504 (a terrestrial magnetism sensor or a compass sensor) for measuring the Earth's magnetic field, an acceleration sensor 3505 for measuring the acceleration of the unmanned aerial vehicle 3001 in flight, a grip sensor 3506 for determining a proximity state of an object or whether an object is held or not, a proximity sensor 3507 for measuring distance (including an ultrasonic sensor for measuring distance by outputting ultrasonic waves and measuring signals reflected from an object), an optical sensor 3508 (an optical flow sensor (OFS)) for calculating position by recognizing the geography or pattern of the ground, a biometric sensor 3509 for user authentication, a temperature/humidity sensor 3510 for measuring temperature and humidity, an illuminance sensor 3511 for measuring illuminance, and an ultra violet (UV) sensor 3512 for measuring UV light. The sensor module 3500 according to various embodiments may compute the posture of the unmanned aerial vehicle 3001. The posture information of the unmanned aerial vehicle 3001 may be shared with the movement control module 3400.

The memory 3700 according to an embodiment of the present disclosure may include an internal memory 3702 and an external memory 3704. The memory 3700 may store commands or data relating to at least one other element of the unmanned aerial vehicle 3001. The memory 3700 may store software and/or a program. The program may include a kernel, middleware, an application programming interface (API), and/or an application program (or “application”).

The audio module 3801 according to an embodiment of the present disclosure may convert sound into an electrical signal, and vice versa. The audio module 3801 may include a speaker and a microphone and may process input or output sound information.

The indicator 3802 according to an embodiment of the present disclosure may display a specific state (e.g., an operating state, a charging state, or the like) of the unmanned aerial vehicle 3001 or a part thereof. Alternatively, the indicator 3802 may display a flight state or an operating mode of the unmanned aerial vehicle 3001.

The power management module 3803 according to an embodiment of the present disclosure may manage, for example, electric power of the unmanned aerial vehicle 3001. According to an embodiment, the power management module 3803 may include a power management integrated circuit (PMIC), a charging IC, or a battery or fuel gauge. The PMIC may have a wired charging method and/or a wireless charging method. The wireless charging method may include, for example, a magnetic resonance method, a magnetic induction method, or an electromagnetic method and may further include an additional circuit for wireless charging, for example, a coil loop, a resonant circuit, a rectifier, or the like. The battery gauge may measure, for example, a remaining capacity of the battery 3804 and a voltage, current or temperature thereof while the battery 3804 is charged.

The battery 3804 according to an embodiment of the present disclosure may include, for example, a rechargeable battery.

The camera module 3630 according to an embodiment of the present disclosure may be configured in the unmanned aerial vehicle 3001, or may be configured in the gimbal module 3600 in the case where the unmanned aerial vehicle 3001 includes a gimbal. The camera module 3630 may include a lens, an image sensor, an image processing unit, and a camera control unit. The camera control unit may adjust composition and/or a camera angle (a photographing angle) for a subject by controlling the angle of the camera lens in four directions (up, down, left and right) on the basis of composition information and/or camera control information output from the processor 3020. The image sensor may include a row driver, a pixel array, a column driver, and the like. The image processing unit may include an image pre-processing unit, an image post-processing unit, a still image codec, a video codec, and the like. The image processing unit may be included in the processor 3020. The camera control unit may control focusing, tracking, and the like.

The camera module 3630 according to an embodiment of the present disclosure may perform a photographing operation in a photographing mode. The camera module 3630 may be affected by a movement of the unmanned aerial vehicle 3001 to a certain degree. The camera module 3630 may be located in the gimbal module 3600 to minimize a change in photography of the camera module 3630 according to a movement of the unmanned aerial vehicle 3001.

The movement control module 3400 according to an embodiment of the present disclosure may control a posture and a movement of the unmanned aerial vehicle 3001 by using position and posture information of the unmanned aerial vehicle 3001. The movement control module 3400 may control roll, pitch, yaw, throttle, and the like of the unmanned aerial vehicle 3001 according to obtained position and posture information. The movement control module 3400 may perform autonomous flight operation control and flight operation control according to a received user input command on the basis of a hovering flight operation and autonomous flight commands (a distance movement command, an altitude movement command, a horizontal and azimuth angle command, and the like) provided by the processor 3020. For example, in the case where the unmanned aerial vehicle 3001 is a quad-copter, the unmanned aerial vehicle 3001 may include a plurality of sub-movement control modules 3440 (microprocessor units (MPUs)), a plurality of motor drive modules 3430, a plurality of motor modules 3420, and a plurality of propellers 3410. The sub-movement control modules 3440 (MPUs) may output control data for rotating the propellers 3410 in response to flight operation control. The motor drive modules 3430 may convert motor control data corresponding to an output of the movement control module 3400 into a drive signal and may output the converted drive signal. The motor modules 3420 (or motors) may control rotation of the corresponding propellers 3410 on the basis of drive signals of the corresponding motor drive modules 3430, respectively.

The gimbal module 3600 according to an embodiment of the present disclosure may include, for example, a gimbal control module 3620, a gyro sensor 3621, an acceleration sensor 3622, a gimbal motor drive module 3623, and a motor 3610. The camera module 3630 may be included in the gimbal module 3600.

The gimbal module 3600 according to an embodiment of the present disclosure may generate compensation data according to a movement of the unmanned aerial vehicle 3001. The compensation data may be data for controlling at least part of pitch or roll of the camera module 3630. For example, the roll/pitch motor 3610 may compensate for roll and pitch of the camera module 3630 according to a movement of the unmanned aerial vehicle 3001. The camera module 3630 may be mounted on the gimbal module 3600 to cancel a movement caused by rotation (e.g., pitch and roll) of the unmanned aerial vehicle 3001 (e.g., a multi-copter) and thus may stably remain in an erected state. The gimbal module 3600 may allow the camera module 3630 to be maintained at a predetermined slope irrespective of a movement of the unmanned aerial vehicle 3001, and thus the camera module 3630 may stably take an image. The gimbal control module 3620 may include a sensor module that includes the gyro sensor 3621 and the acceleration sensor 3622. The gimbal control module 3620 may analyze measurement values of the sensor module including the gyro sensor 3621 and the acceleration sensor 3622 to generate a control signal of the gimbal motor drive module 3623 and to drive the motor 3610 of the gimbal module 3600.

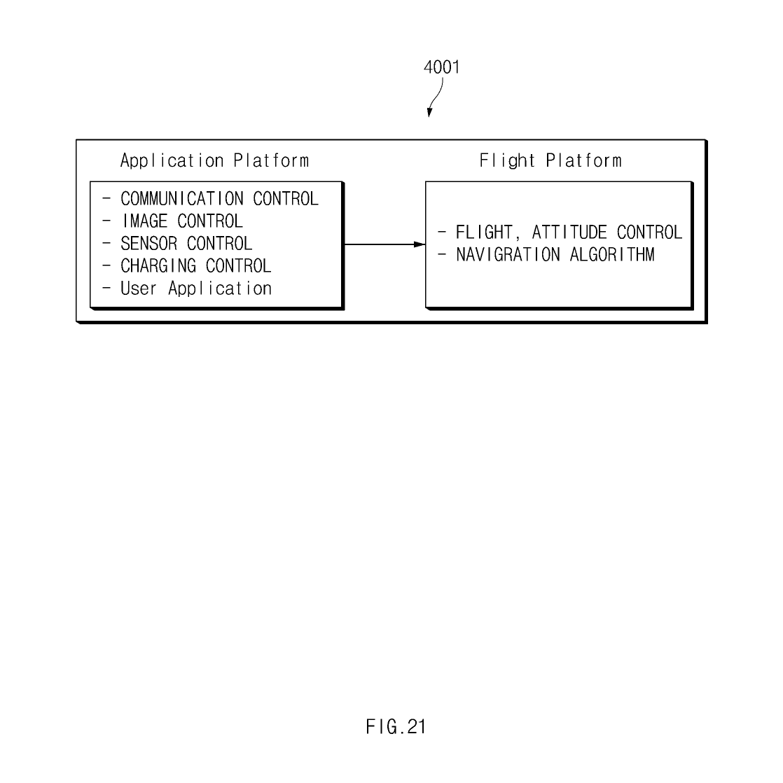

FIG. 21 illustrates a program module of an unmanned aerial vehicle according to an embodiment of the present disclosure.

Referring to FIG. 21, an unmanned aerial vehicle 4001 may include an application platform or a flight platform. The unmanned aerial vehicle 4001 may include at least one application platform for operating the unmanned aerial vehicle 4001 and providing a service by receiving a control signal through a wireless link and at least one flight platform for controlling flight depending on a navigation algorithm.

The application platform according to an embodiment of the present disclosure may perform communication control (connectivity), image control, sensor control, and charging control on elements of the unmanned aerial vehicle 4001 and may perform an operation change according to a user application. The application platform may be executed in a processor. The flight platform may execute flight, posture control, or a navigation algorithm of the unmanned aerial vehicle 4001. The flight platform may be executed in the processor or a movement control module. The application platform may send a control signal to the flight platform while performing the communication, image, sensor, and charging controls.

According to one embodiment, the processor may obtain an image of a subject taken through a camera module. The processor may analyze the obtained image to generate a command to pilot the unmanned aerial vehicle 4001. For example, the processor may generate information about the size and moving state of the subject, a relative distance between a photographing device and the subject, altitude information, and azimuth angle information. The processor may generate a tracking flight control signal of the unmanned aerial vehicle 4001 by using the computed information. The flight platform may pilot the unmanned aerial vehicle 4001 (may control the posture and movement of the unmanned aerial vehicle 4001) by controlling the movement control module based on the received control signal.

The position, flight posture, angular velocity, and acceleration of the unmanned aerial vehicle 4001 may be measured through a GPS module and a sensor module. Output information of the GPS module and the sensor module may be generated and may be basic information of a control signal for navigation/automatic control of the unmanned aerial vehicle 4001. Information of a barometric pressure sensor capable of measuring altitude through an atmospheric pressure difference according to flight of an unmanned photographing device and information of ultrasonic sensors capable of performing accurate altitude measurement at a low altitude may also be used as basic information. In addition, a control data signal received from a remote controller, battery state information of the unmanned aerial vehicle 4001, and the like may also be used as basic information of a control signal.

The unmanned aerial vehicle 4001 according to an embodiment of the present disclosure may fly using a plurality of propellers. The propellers may change a rotational force of a motor to a propulsive force. The unmanned aerial vehicle 4001 may be referred to as a quad-copter, a hexa-copter, or an octo-copter according to the number of rotors (propellers), in which the quad-copter has four rotors (propellers), the hexa-copter has six rotors (propellers), and the octo-copter has eight rotors (propellers).

The unmanned aerial vehicle 4001 according to an embodiment of the present disclosure may control the propellers based on a received control signal. The unmanned aerial vehicle 4001 may fly by two principles: lift and torque. The unmanned aerial vehicle 4001 may rotate one half the multiple propellers in the clockwise (CW) direction and the other half in the counter clockwise (CCW) direction for rotation. The three-dimensional coordinates of a drone according to flight may be determined by pitch (Y)/roll (X)/yaw (Z). The unmanned aerial vehicle 4001 may tilt forwards, backwards, leftwards, or rightwards to fly. If the unmanned aerial vehicle 4001 tilts, the direction of air flow generated by the propellers (rotors) may be changed. For example, if the unmanned aerial vehicle 4001 tilts forwards, air may flow slightly backwards, as well as upwards and downwards. Accordingly, the unmanned aerial vehicle 4001 may move forwards by the air layer pushed backwards according to the law of action and reaction. The unmanned aerial vehicle 4001 may be tilted in a direction by decreasing the speed of motors on the front side thereof and increasing the speed of motors on the rear side thereof in the corresponding direction. Since this method is common to all directions, the unmanned aerial vehicle 4001 may be tilted and moved by only adjusting the speed of the motor module (rotors).

In the unmanned aerial vehicle 4001 according to an embodiment of the present disclosure, the flight platform may receive a control signal generated by the application platform to control the motor module, thereby controlling the pitch (Y)/roll (X)/yaw (Z) of the unmanned aerial vehicle 4001 and performing flight control according to a moving path.

While the present disclosure has been shown and described with reference to various embodiments thereof, it will be understood by those skilled in the art that various changes in form and details may be made therein without departing from the spirit and scope of the present disclosure as defined by the appended claims and their equivalents.

While the present disclosure has been shown and described with reference to various embodiments thereof, it will be understood by those skilled in the art that various changes in form and details may be made therein without departing from the spirit and scope of the present disclosure as defined by the appended claims and their equivalents.

Certain aspects of the above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

What is claimed is:

1. An electronic device, comprising:
a housing;
a display;
at least one first sensor located in the housing and configured to generate first data associated with an orientation of the housing;
a second sensor located in the housing and configured to generate second data associated with a location of the housing;
a wireless communication circuit located in the housing;
a processor located in the housing and electrically connected to the display, the at least one first sensor, the second sensor, and the wireless communication circuit; and
a memory located in the housing,
wherein the memory stores instructions, when executed, cause the processor to:
establish a wireless communication channel with an unmanned aerial vehicle (UAV) via the wireless communication circuit;
receive the first data from the at least one first sensor;
obtain the orientation of the housing based on at least part of the received first data;
receive the second data from the second sensor;
obtain the location of the housing based on at least part of the received second data;
based on the orientation and/or the location, determine a valid range in which the UAV can operate; and
transmit a control signal to the UAV via the wireless communication circuit,
wherein the control signal is executed by the UAV such that the UAV stays within in the valid range.

2. The electronic device of claim 1, wherein the valid range is in a quadrangular pyramid shape.

3. The electronic device of claim 2, wherein the quadrangular pyramid shape comprises a vertex adjacent to the location of the housing or the location of the housing.

4. The electronic device of claim 1, wherein the valid range is in a conical shape extending from the electronic device to the UAV, the conical shape defined by a vertex adjacent to the housing, and a first virtual line and a second virtual line extending from the electronic device to the UAV, and
wherein at the vertex, the first virtual line forms an angle with the second virtual line.

5. The electronic device of claim 4, wherein the angle is an acute angle.

6. The electronic device of claim 4, wherein the angle is in a range of 40 degrees to 180 degrees.

7. The electronic device of claim 1, wherein the control signal is executed by the UAV such that the UAV moves to be within a specified distance of a boundary of the valid range.

8. An electronic device, comprising:
a communication circuit configured to establish a communication channel with an aerial vehicle;
a sensor configured to collect location information and orientation information;
a memory configured to store an application associated with controlling the aerial vehicle; and
a processor electrically connected with the communication circuit, the sensor, and the memory,
wherein the processor is configured to:
calculate a valid range defining a space where it is possible to operate the aerial vehicle, based on location and/or orientation information of the electronic device.

9. The electronic device of claim 8, wherein the processor is further configured to:
obtain a setting value stored in the memory; and
adjust at least one of a size of the valid range and a shape of the valid range depending on the obtained setting value.

10. The electronic device of claim 9, wherein the shape of the valid range is a quadrangular pyramid or a cone.

11. The electronic device of claim 9, wherein a distance between the valid range and ground is equal to or greater than a predetermine value.

12. The electronic device of claim 8, wherein the processor is further configured to:
if at least one of the location or the orientation of the electronic device is changed, recalculate a changed valid range in response to the changed location or orientation; and
transmit information about the changed valid range to the aerial vehicle.

13. The electronic device of claim 8, further comprising:
a camera configured to obtain an image in an image capture angle,
wherein the processor is further configured to:
set a field of view (FOV) of the camera to the valid range.

14. The electronic device of claim 8, further comprising:
a display,
wherein the processor is further configured to:
output a virtual object indicating the valid range on the display.

15. The electronic device of claim 8, wherein the processor is further configured to:
collect location information of the aerial vehicle;
determine whether the aerial vehicle is within the valid range;
if the aerial vehicle is outside the valid range, automatically generate control information such that the aerial vehicle moves to be within the valid range; and
transmit the control information to the aerial vehicle.

16. The electronic device of claim 8, wherein the processor is further configured to:
transmit valid range information calculated in real time according to current location and/or orientation information to the aerial vehicle.

17. A method for controlling operation of a UAV, the method comprising:
establishing, by an electronic device, a communication channel with the UAV;
collecting, by the electronic device, location information and orientation information of the electronic device;
calculating, by the electronic device, a valid range defining a space where it is possible to operate the UAV, based on the collected location and/or orientation information of the electronic device;
collecting, by the electronic device, location information of the UAV;
determine, by the electronic device, whether the UAV is within the valid range based on the location information of the UAV; and
transmitting, by the electronic device, control information associated with operating the UAV to the UAV as a result of the determination.

18. The method of claim 17, wherein the transmitting further comprises:
if the UAV is outside the valid range, automatically generating the control information, wherein the control information is for moving the UAV to be within the valid range.

19. The method of claim 17, wherein the transmitting further comprises:
collecting a user input through the electronic device while the UAV is within the valid range; and
generating the control information in response to the user input, wherein the control information is for moving the UAV to a specified distance at a specified speed in a specified direction.

20. The method of claim 17, wherein the calculating further comprises:
obtaining a setting value stored in a memory of the electronic device; and
adjusting at least one of a size of the valid range and a shape of the valid range depending on the obtained setting value.
